(19) United States
(12) Patent Application Publication
(10) Pub. No.: US 2010/0175401 A1
(43) Pub. Date: Jul. 15, 2010

(54) DISPLACEMENT CONTROL SYSTEM FOR A VARIABLE DISPLACEMENT COMPRESSOR

(76) Inventors: Yukihiko Taguchi, Gunma (JP); Yoshihiro Ochiai, Gunma (JP)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/666,593

(22) PCT Filed: Jun. 25, 2008
(86) PCT No.: PCT/JP2008/061567

§ 371 Date: Dec. 23, 2009

(30) Foreign Application Priority Data
Jun. 26, 2007 (JP) 2007-167541

(51) Int. Cl. B60H 1/32; F04B 49/06; F04B 27/14; F25B 1/02

(52) U.S. Cl. 62/228.3; 417/212

(57) ABSTRACT

A discharge displacement control system for a variable displacement compressor includes controlled object setting means. The controlled object setting means selects a control mode out of two or more control modes in accordance with external information detected by external information detection means, and sets a controlled object matching the selected control mode. In accordance with the external information detected by the external information detection means, the controlled object setting means sets, as the controlled object, a target pressure for one of a pressure in a suction pressure region and a pressure in a crank chamber in a first control mode, which is one of the control modes, and a target working pressure difference between a pressure in a discharge pressure region and one of the pressure in the suction pressure region and the pressure in the crank chamber in a second control mode, which is another of the control modes.

### TECHNICAL FIELD

The present invention relates to a displacement control system for a variable displacement compressor used in an air conditioning system.

### BACKGROUND ART

A reciprocating-type variable displacement compressor used in an automotive air conditioning system, for example, includes a housing having a discharge chamber, a suction chamber, a crank chamber and cylinder bores defined therein. A drive shaft extending through the crank chamber is coupled with a swash plate such that the swash plate is tiltable relative to the drive shaft. A conversion mechanism including the swash plate converts rotation of the drive shaft to reciprocating motion of pistons received in the respective cylinder bores. The reciprocating motion of each piston causes a series of processes to take place, the processes including a suction process in which a working fluid is sucked from the suction chamber into the corresponding cylinder bore, a compression process in which the sucked working fluid is compressed, and a discharge process in which the compressed working fluid is discharged to the discharge chamber.

The stroke length of the individual pistons, that is, the discharge capacity or displacement of the compressor, can be varied by changing the pressure (control pressure) in the crank chamber. In order to control the discharge displacement, a displacement control valve is arranged in a supply passage communicating the discharge chamber with the crank chamber, and a constriction is formed in an extraction passage communicating the crank chamber with the suction chamber.

The displacement control valve disclosed in Patent Document 1 (Japanese Laid-open Patent Publication No. 09-268973), for example, has a pressure-sensitive member built therein for sensing the suction pressure. In the variable displacement compressor using the displacement control valve, the discharge displacement is subjected to feedback control using the sensed suction pressure. Specifically, the pressure-sensitive member is constituted by a bellows, for example, and as the suction pressure lowers, the bellows extends and increases the opening of the supply passage, to thereby decrease the discharge displacement.

Also, Patent Document 2 (Japanese Laid-open Patent Publication No. 2001-107854) discloses a displacement control method for a variable displacement compressor, wherein displacement control is performed such that the difference between pressures monitored at two pressure monitoring points approaches a target value.

Further, in the displacement control device disclosed in Patent Document 3 (Japanese Laid-open Patent Publication No. 2001-132650), the discharge displacement is subjected to feedback control such that the pressure difference (differential pressure) between the pressure (discharge pressure) in the discharge chamber and the pressure in the suction chamber approaches a target value. Specifically, in the control device of Patent Document 3, the differential pressure is used as an object to be controlled and the amount of electric current supplied to the displacement control valve is varied to control the differential pressure, so that the discharge displacement varies. For example, when the differential pressure decreases, the control device increases the discharge displacement so that the differential pressure may approach a predetermined value.

The differential pressure control executed by the displacement control device of Patent Document 3 is thought to be similar in control scheme to the displacement control method of Patent Document 2 in that the difference between the pressures monitored at two monitoring points is made to approach the target value. Thus, displacement control devices for variable displacement compressors can be roughly classified into two types according to control schemes, namely, the suction pressure control type using the suction pressure as the controlled object, as typified by Patent Document 1, and the differential pressure control type using the differential pressure as the controlled object, as typified by Patent Documents 2 and 3.

The suction pressure control scheme using the suction pressure as the controlled object is suited as a discharge displacement control method for an air conditioning system and is currently the most widely used technique. When the discharge displacement is to be decreased according to the suction pressure control scheme, the target value for the suction pressure, which is the controlled object, is changed to a larger value. With this control scheme, the heat load applied, for example, to the refrigeration cycle is high, and also if the rotational speed of the compressor is low, the discharge displacement occasionally fails to be decreased satisfactorily. Further, in cases where the actual suction pressure is higher than the upper limit of the suction pressure control range, the discharge displacement possibly becomes totally uncontrollable.

Also, where the suction pressure is used as the controlled object, a pressure-sensitive member for sensing the suction pressure, such as a bellows or a diaphragm, needs to be built into the displacement control valve, making the displacement control valve complicated in structure. Moreover, there are restrictions on the dimensions of the pressure-sensitive member, and in order to raise the upper limit of the suction pressure control range, a larger-sized solenoid needs to be used.

Meanwhile, in the air conditioning system for a motor vehicle, the variable displacement compressor in operation imposes a large load on the engine of the vehicle. Thus, when the vehicle is accelerated or climbing a hill, for example, the discharge displacement is temporarily decreased to thereby lower the drive load required to drive the compressor. Namely, as much motive power of the engine as possible is allocated to the travel of the vehicle while ensuring a certain level of air conditioning capacity. If the heat load is large in such a situation, the suction pressure becomes uncontrollable in the case of the suction pressure control scheme. As a result, the operation of the compressor has to be stopped, sacrificing the air conditioning of the vehicle compartment.

The differential pressure control scheme typified by Patent Documents 2 and 3 has been devised to eliminate the shortcomings associated with the suction pressure control scheme. With the differential pressure control scheme, the discharge displacement is promptly changed by external control, irrespective of heat load. The differential pressure control scheme, however, has the following shortcomings.

Where feedback control is performed on the discharge displacement such that the difference between the pressures monitored at the two monitoring points approaches a target value, the discharge displacement is increased when the pressure difference becomes smaller than the target value. With this control scheme, if the amount of the refrigerant circulating through the circulation path is smaller than a proper amount, the discharge displacement is increased in order to cause the pressure difference to approach the target value. The reason is that the pressure difference between the pressure monitoring points is smaller when the circulation amount of the refrigerant is deficient than when the refrigerant circulation amount is proper.

The deficiency in the refrigerant circulation amount is caused also by a shortage of the refrigerant in the circulation path. While the amount of the refrigerant is short, the differential pressure does not reach the target value even if the discharge displacement is increased. Thus, where feedback control is performed on the pressure difference while the refrigerant amount is short, the discharge displacement is rapidly increased by a large margin, so that the compressor is eventually kept operating at its maximum displacement. Such operation, however, possibly damages the compressor.

From the standpoint of coping with the shortage of the refrigerant amount, the suction pressure control scheme is superior to the differential pressure control scheme. Specifically, with the suction pressure control scheme, when the suction pressure becomes smaller than the target value due to the shortage of the refrigerant amount, the discharge displacement is decreased finally to its minimum displacement in order to keep the suction pressure at a predetermined value. Namely, the suction pressure control scheme additionally has a fail-safe function.

As explained above, the suction pressure control scheme and the differential pressure control scheme individually have their own merits and demerits, and when every factor is taken into consideration, it cannot be said which one of the control schemes is better than the other. Ideally, during the normal operation, the discharge displacement is controlled according to the suction pressure control scheme to ensure comfortable air conditioning, and when transitional control is required such as during the acceleration or hill-climbing of the vehicle, the discharge displacement is preferably controlled according to the differential pressure control scheme. A displacement control device capable of such control is, however, not developed yet.

### DISCLOSURE OF THE INVENTION

An object of the present invention is to provide a displacement control system for a variable displacement compressor which system is simple in construction and yet is capable of selectively executing suction pressure control and differential pressure control in accordance with various conditions.

To achieve the object, the present invention provides a displacement control system for a variable displacement compressor which is inserted, together with a heat radiator, an expansion device and an evaporator, in a circulation path for circulating a refrigerant, to constitute a refrigeration cycle of an air conditioning system and which includes a housing having a discharge chamber, a suction chamber, a crank chamber and cylinder bores defined therein, pistons received in the respective cylinder bores, a drive shaft rotatably supported in the housing, a conversion mechanism including a tiltable swash plate element for converting rotation of the drive shaft to reciprocating motion of the pistons, and a displacement control valve having a valve element applied with at least one of a pressure in a suction pressure region of the refrigeration cycle and a pressure in the crank chamber, and also with a pressure in a discharge pressure region of the refrigeration cycle and an electromagnetic force of a solenoid to open and close a valve opening and thereby vary the pressure in the crank chamber. The displacement control system comprises: external information detection means for detecting one or more items of external information; controlled object setting means for setting a controlled object to be controlled, in accordance with the external information detected by the external information detection means; control signal calculation means for calculating a discharge displacement control signal in accordance with the controlled object set by the controlled object setting means; and solenoid driving means for supplying the solenoid with an electric current based on the discharge displacement control signal calculated by the control signal calculation means. The controlled object setting means selects one control mode out of two or more control modes in accordance with the external information detected by the external information detection means, and sets the controlled object matching the selected control mode. In a first control mode which is one of the control modes, the controlled object setting means sets a target pressure for one of the pressure in the suction pressure region and the pressure in the crank chamber, as the controlled object in accordance with the external information detected by the external information detection means, and in a second control mode which is one of the control modes, the controlled object setting means sets a target working pressure difference for a difference between the pressure in the discharge pressure region and one of the pressure in the suction pressure region and the pressure in the crank chamber, as the controlled object in accordance with the external information detected by the external information detection means.

In the displacement control system of the present invention, the controlled object setting means selects one of the first and second control modes in accordance with the external information, and suction pressure control is executed in the first control mode while differential pressure control is executed in the second control mode.

With the displacement control system, therefore, the discharge displacement can be optimized in accordance with operating conditions. For example, during the normal operation, the discharge displacement can be controlled by the suction pressure control, and when transitional control is required such as during the acceleration or hill-climbing of the vehicle, the discharge displacement can be controlled by the differential pressure control.

Preferably, the external information detection means includes discharge pressure detection means for detecting the pressure in the discharge pressure region, and when the first control mode is executed by the controlled object setting means, the control signal calculation means calculates the discharge displacement control signal based on the pressure in the discharge pressure region, detected by the discharge pressure detection means, and the target pressure.

In the preferred displacement control system, when the first control mode is executed by the controlled object setting means, the control signal calculation means calculates the discharge displacement control signal based on the pressure in the discharge pressure region and the target pressure. Thus, the suction pressure control can be executed even if the displacement control valve used is simple in construction.

The discharge pressure detection means is conventionally used as an element indispensable for the protection of the variable displacement compressor and the air conditioning system and is not an element newly used in the invention. Accordingly, the construction of the air conditioning system does not become complicated due to the application of the displacement control system.

Preferably, the control signal calculation means calculates the discharge displacement control signal based on a difference between the pressure in the discharge pressure region and the target pressure.

In the preferred displacement control system, the discharge displacement control signal is calculated on the basis of the difference between the pressure in the discharge pressure region and the target pressure. This permits the discharge displacement to be controlled reliably such that the pressure in the suction pressure region or the pressure in the crank chamber approaches the target pressure.

Preferably, the external information detection means includes evaporator outlet air temperature detection means for detecting temperature of air just left the evaporator and target evaporator outlet air temperature setting means for setting a target temperature of the air just left the evaporator, and when executing the first control mode, the controlled object setting means sets the target pressure such that the temperature of the air detected by the evaporator outlet air temperature detection means approaches the target temperature set by the target evaporator outlet air temperature setting means.

In the preferred displacement control system, feedback control is performed on the discharge displacement such that the temperature of the air just left the evaporator approaches the target temperature. This makes it possible to improve the accuracy in controlling the temperature of, for example, a vehicle compartment air-conditioned by the air conditioning system to which the displacement control system is applied.

Preferably, the external information detection means includes target torque setting means for setting a target torque of the variable displacement compressor, and when executing the second control mode, the controlled object setting means sets the target working pressure difference such that torque of the variable displacement compressor approaches the target torque set by the target torque setting means.

With the preferred displacement control system, the torque (drive load) of the variable displacement compressor can be made to approach the target torque. Thus, the displacement control can be performed so as to ensure stability of the engine control as well as traveling performance of the vehicle.

Preferably, the external information detection means includes air conditioner switch detection means for detecting a change from non-operating state to operating state of the air conditioning system, and one of the condition which the controlled object setting means executes the second control mode is fulfilled that the change from non-operating state to operating state of the air conditioning system is detected by the air conditioner switch detection means.

With the preferred displacement control system, the torque of the variable displacement compressor can be made to approach the target torque when the state of the air conditioning system has switched from non-operating state to operating state, whereby stability of the engine control is ensured.

Preferably, the second control mode is continuously executed for a predetermined time after the second control mode is started.

In the preferred displacement control system, the second control mode is continued over the predetermined time, thereby ensuring stability of the engine control.

Preferably, the air conditioning system is mounted on a motor vehicle, the external information detection means includes idling detection means for detecting an idling state of the vehicle, and one of the condition which the controlled object setting means executes the second control mode is fulfilled that the idling state of the vehicle is detected by the idling detection means.

With the preferred displacement control system, the torque of the variable displacement compressor can be made to approach the target torque when the vehicle is in an idling state. This serves to stabilize the engine control.

Preferably, the controlled object setting means stores the target pressure immediately before a switchover from the first control mode to the second control mode and, when the second control mode is canceled and the first control mode is again executed, sets the stored target pressure as an initial value for a new target pressure.

In the preferred displacement control system, a new target pressure is set using the stored target pressure. Thus, in a situation where the control mode is switched from the first control mode to the second control mode and then again to the first control mode, the vehicle interior which is air-conditioned by the air conditioning system can be quickly restored to the previous air-conditioned state of the first control mode.

Preferably, the air conditioning system is mounted on a motor vehicle, the external information detection means includes engine load detection means for detecting a load on an engine of the vehicle, and one of the condition which the controlled object setting means executes the second control mode is fulfilled that the load of the engine detected by the engine load detection means is larger than or equal to a predetermined value.

With the preferred displacement control system, the torque of the variable displacement compressor can be made to approach the target torque when the engine load is larger than or equal to the predetermined value, thereby ensuring traveling performance of the vehicle.

Preferably, the air conditioning system is mounted on a motor vehicle, the external information detection means includes engine load detection means for detecting a load on an engine of the vehicle and heat load detection means for detecting a heat load both inside and outside of the vehicle, and one of the condition which the controlled object setting means executes the second control mode is fulfilled that both of the engine load detected by the engine load detection means and the heat load detected by the heat load detection means are larger than or equal to respective predetermined values.

In the preferred displacement control system, the second control mode is executed only when both of the engine load and the heat load both the inside and outside of the vehicle are larger than or equal to the respective predetermined values. This prevents unnecessary execution of the second control mode, making it possible to keep the vehicle interior comfortably air-conditioned.

Preferably, the condition for executing the second control mode by the controlled object setting means includes an additional condition that an amount of current supplied to the solenoid during execution of the first control mode is larger than that supplied to the solenoid if the second control mode is executed.

In the preferred displacement control system, the condition for executing the second control mode includes the additional condition that the amount of current supplied to the solenoid in the first control mode is larger than that supplied to the solenoid if the second control mode is executed. Accordingly, unnecessary execution of the second control mode is prevented, whereby the vehicle interior can be kept comfortably air-conditioned.

Preferably, the controlled object setting means stores the target pressure immediately before a switchover from the first control mode to the second control mode and, when the second control mode is canceled and the first control mode is again executed, sets the stored target pressure as an initial value for a new target pressure.

In the preferred displacement control system, a new target pressure is set using the stored target pressure. Thus, in a situation where the control mode is switched from the first control mode to the second control mode and then again to the first control mode, the vehicle interior which is air-conditioned by the air conditioning system can be quickly restored to the previous air-conditioned state of the first control mode.

Preferably, when executing the second control mode, the controlled object setting means sets the target working pressure difference such that the temperature of the air detected by the evaporator outlet air temperature detection means approaches the target temperature set by the target evaporator outlet air temperature setting means.

In the preferred displacement control system, when the outside air temperature is high, for example, the controlled object setting means executes the second control mode, instead of the first control mode. In the second control mode, the working pressure difference is set such that the temperature of the air just left the evaporator approaches the target temperature. Thus, in a situation where the outside air temperature is so high that the displacement cannot be controlled by the suction pressure control, the displacement can be satisfactorily controlled by the differential pressure control, whereby the vehicle compartment or the like which is air-conditioned by the air conditioning system can be can be kept comfortable.

Preferably, the electric current supplied to the solenoid in accordance with the target working pressure difference is restricted to a predetermined upper-limit value or less.

In the preferred displacement control system, the current supplied to the solenoid is restricted to the upper-limit value or less, whereby the torque of the variable displacement compressor can be restricted by means of the upper-limit value.

Preferably, the air conditioning system is mounted on a motor vehicle, the external information detection means includes heat load detection means for detecting a heat load both inside and outside of the vehicle, and one of the condition which the controlled object setting means executes the second control mode is fulfilled that the heat load detected by the heat load detection means is larger than or equal to a predetermined value.

In the preferred displacement control system, when the heat load both the inside and outside of the vehicle is larger than or equal to the predetermined value, the controlled object setting means executes the second control mode, instead of the first control mode, and sets the working pressure difference such that the temperature of the air just left the evaporator approaches the target temperature. Thus, in a situation where the heat load is so high that the displacement fails to be controlled by the suction pressure control, the displacement can be satisfactorily controlled by the differential pressure control, whereby the vehicle compartment or the like which is air-conditioned by the air conditioning system can be can be kept comfortable.

Preferably, the air conditioning system is mounted on a motor vehicle, the external information detection means includes heat load detection means for detecting a heat load both inside and outside of the vehicle and rotational speed detection means for detecting a physical quantity corresponding to rotational speed of the variable displacement compressor, and one of the condition which the controlled object setting means executes the second control mode is fulfilled that both of the heat load detected by the heat load detection means and the physical quantity detected by the rotational speed detection means are larger than or equal to respective predetermined values.

In the preferred displacement control system, when the heat load both the inside and outside of the vehicle and the rotational speed of the variable displacement compressor are larger than or equal to the respective predetermined values, the controlled object setting means executes the second control mode, instead of the first control mode. In the second control mode, the working pressure difference is set such that the temperature of the air just left the evaporator approaches the target temperature. Thus, in a situation where the heat load is so high that the displacement cannot be controlled by the suction pressure control, the displacement can be satisfactorily controlled by the differential pressure control, whereby the vehicle compartment or the like which is air-conditioned by the air conditioning system can be can be kept comfortable. Also, since the second control mode is executed only when both of the heat load between the inside and outside of the vehicle and the rotational speed of the variable displacement compressor are larger than or equal to the respective predetermined values, unnecessary execution of the second control mode is prevented, making it possible to keep the vehicle interior comfortably air-conditioned.

Preferably, the air conditioning system further includes a hot gas heater cycle and is capable of switching between the refrigeration cycle and the hot gas heater cycle, the variable displacement compressor constitutes not only part of the refrigeration cycle but also part of the hot gas heater cycle of the air conditioning system, the external information detection means includes cycle detection means for detecting an operating cycle out of the refrigeration cycle and the hot gas heater cycle, and during operation of the hot gas heater cycle, the controlled object setting means executes the second control mode.

In the preferred displacement control system, the controlled object setting means executes the second control mode during the operation of the hot gas heater cycle. The controlled object of the second control mode is not the suction pressure, and therefore, the discharge displacement can be optimally controlled in low-temperature environments requiring heating operation of the air conditioning system.

Consequently, the vehicle interior or the like which is air-conditioned by the air conditioning system can be kept comfortable.

Preferably, the external information detection means includes exchanger outlet air temperature detection means for detecting temperature of air just left an air-heating heat exchanger constituting part of the hot gas heater cycle and target exchanger outlet air temperature setting means for setting a target temperature of the air just left the air-heating heat exchanger, and when executing the second control mode, the controlled object setting means sets the target working pressure difference such that the temperature of the air detected by the exchanger outlet air temperature detection means approaches the target temperature set by the target exchanger outlet air temperature setting means.

In the preferred displacement control system, feedback control is performed on the discharge displacement such that the temperature of the air just left the air-heating heat exchanger approaches the target temperature. This makes it possible to improve the accuracy in controlling the temperature of, for example, a vehicle compartment air-conditioned by the air conditioning system to which the displacement control system is applied.

Preferably, the discharge pressure detection means detects the pressure of the refrigerant in that portion of the discharge pressure region of the circulation path which is shared by the refrigeration cycle and the hot gas heater cycle.

In the preferred displacement control system, the discharge pressure detection means is arranged at that portion of the discharge pressure region of the circulation path which is shared by the refrigeration cycle and the hot gas heater cycle. Thus, the discharge pressure detection means is allowed to function regardless of whether the refrigeration cycle or the hot gas heater cycle is operating.

Preferably, when a third control mode, which is one of the control modes, is executed, the controlled object setting means sets a target discharge pressure as a target for the pressure in the discharge pressure region, and sets the target working pressure difference such that the pressure in the discharge pressure region, detected by the discharge pressure detection means, approaches the target discharge pressure.

With the preferred displacement control system, anomalous rise in the pressure of the discharge pressure region can be prevented, thus ensuring the reliability of the variable displacement compressor and the air conditioning system.

### BRIEF DESCRIPTION OF THE DRAWINGS

The present invention will become more fully understood from the detailed description given hereinafter and the accompanying drawings which are given by way of illustration only, and thus, are not limitative of the present invention, and wherein:

FIG. 1 is a longitudinal sectional view of a variable displacement compressor and also illustrates a schematic construction of a refrigeration cycle of an automotive air conditioning system to which a displacement control system A according to a first embodiment is applied;

FIG. 2 illustrates connections of a displacement control valve in the variable displacement compressor shown in FIG. 1;

FIG. 3 is a block diagram illustrating a schematic configuration of the displacement control system of the first embodiment;

FIG. 4 is a control flowchart illustrating a main routine executed by the displacement control system of FIG. 3;

FIG. 5 is a control flowchart illustrating a suction pressure control routine included in the main routine of FIG. 4;

FIG. 6 is a control flowchart illustrating a target suction pressure setting routine included in the suction pressure control routine of FIG. 5;

FIG. 7 is a control flowchart illustrating a differential pressure control routine included in the main routine of FIG. 4;

FIG. 8 illustrates a method of setting a target torque in a start mode, the target torque being read in the differential pressure control routine of FIG. 7;

FIG. 9 illustrates a method of setting the target torque in an idling mode, the target torque being read in the differential pressure control routine of FIG. 7;

FIG. 10 illustrates a method of setting the target torque in an acceleration mode, the target torque being read in the differential pressure control routine of FIG. 7;

FIG. 11 illustrates an operation of the displacement control system of FIG. 3 over a predetermined time from the start of an engine of a motor vehicle;

FIG. 12 is a control flowchart illustrating a discharge pressure control routine included in the main routine of FIG. 4;

FIG. 13 is a graph illustrating the relationship of control current with target suction pressure and discharge pressure;

FIG. 14 is a graph illustrating the relationship between control current and working pressure difference (Pd−Ps);

FIG. 15 is a block diagram illustrating a schematic configuration of a displacement control system according to a second embodiment;

FIG. 16 is a control flowchart illustrating part of a main routine executed by the displacement control system of FIG. 15;

FIG. 17 is a control flowchart illustrating a differential pressure control routine (for air-conditioning control) included in the main routine of FIG. 16;

FIG. 18 is a control flowchart illustrating another example of the part of the main routine executed by the displacement control system of FIG. 15;

FIG. 19 illustrates switching operation in accordance with the discrimination of outside air temperature in the control flowchart of FIG. 18; and

FIG. 20 illustrates a schematic construction of a refrigeration cycle and hot gas heater cycle of an automotive air conditioning system to which a displacement control system according to a third embodiment is applied.

### BEST MODE OF CARRYING OUT THE INVENTION

First, a displacement control system A for a variable displacement compressor according to a first embodiment will be described.

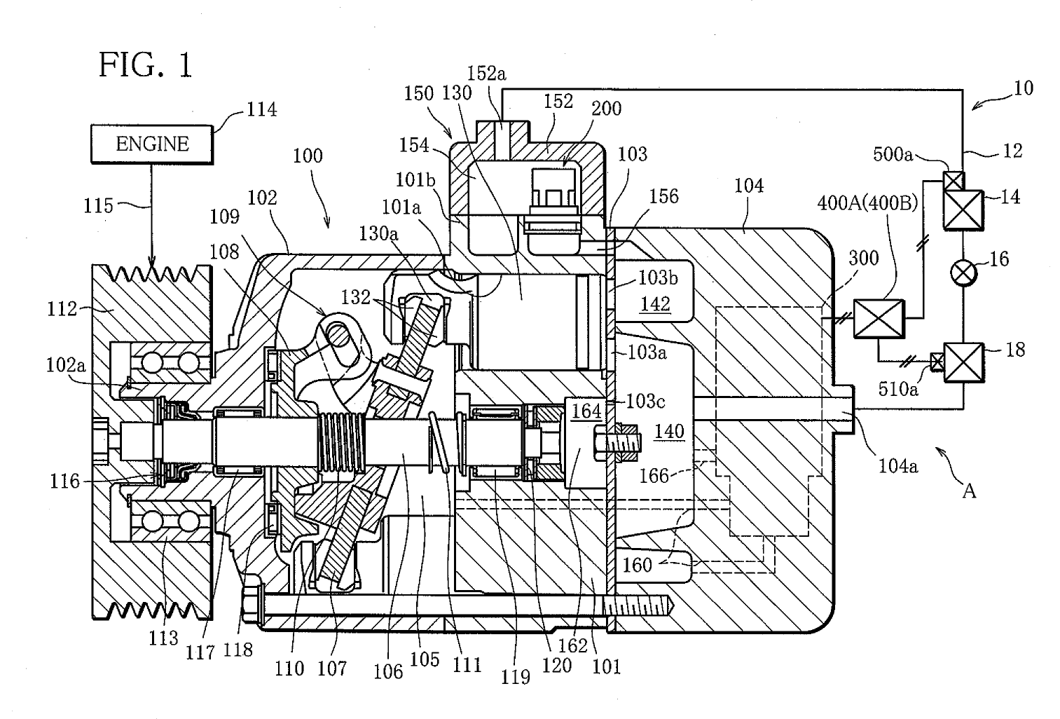

FIG. 1 illustrates a refrigeration cycle 10 of an automotive air conditioning system to which the displacement control system A is applied. The refrigeration cycle 10 comprises a circulation path 12 through which a refrigerant as a working fluid is circulated, and has a compressor 100, a heat radiator (condenser) 14, an expansion device (expansion valve) 16 and an evaporator 18 successively inserted in the circulation path 12 in the order mentioned as viewed in the flowing direction of the refrigerant. When the compressor 100 is operated, the refrigerant circulates through the circulation path 12. Specifically, the compressor 100 performs a series of processes including a process of sucking in the refrigerant, a process of compressing the sucked refrigerant, and a process of discharging the compressed refrigerant.

The evaporator 18 also constitutes part of an air circuit of the automotive air conditioning system. Because of the heat of vaporization of the refrigerant in the evaporator 18, the air passing by the evaporator 18 is cooled.

The compressor 100 to which the displacement control system A of the first embodiment is applied is a variable displacement compressor, for example, a swash plate-type clutchless compressor. The compressor 100 comprises a cylinder block 101 having a plurality of cylinder bores 101a formed therethrough. A front housing 102 is attached to one end of the cylinder block 101, and a rear housing (cylinder head) 104 is attached to the other end of the cylinder block 101 with a valve plate 103 interposed therebetween.

The cylinder block 101 and the front housing 102 cooperatively define a crank chamber 105, and a drive shaft 106 extends through the crank chamber 105 in the longitudinal direction of the compressor. The drive shaft 106 penetrates through an annular swash plate 107 arranged in the crank chamber 105, and the swash plate 107 is hinged, through a coupler 109, to a rotor 108 fixed on the drive shaft 106. Accordingly, the swash plate 107 is movable along and also tiltable relative to the drive shaft 106.

A coil spring 110 is disposed around a portion of the drive shaft 106 extending between the rotor 108 and the swash plate 107, to press the swash plate 107 in a direction toward a minimum tilt angle. Another coil spring 111 is disposed on the other side of the swash plate 107, that is, around a portion of the drive shaft 106 extending between the swash plate 107 and the cylinder block 101, to press the swash plate 107 in a direction toward a maximum tilt angle.

The drive shaft 106 penetrates through a boss 102a protruding outward from the front housing 102, and a pulley 112 serving as a power transmission device is coupled to the outer end of the drive shaft 106. The pulley 112 is rotatably supported on the boss 102a with a ball bearing 113 therebetween, and a belt 115 is passed around the pulley 112 to connect the pulley 112 to an automotive engine 114 serving as an external drive source.

A shaft seal 116 is arranged inside the boss 102a and seals the interior of the front housing 102 off from the outside of same. The drive shaft 106 is rotatably supported in both radial and thrust directions by bearings 117, 118, 119 and 120. Motive power is transmitted from the engine 114 to the pulley 112, and thus the drive shaft 106 is rotatable together with the pulley 112.

Pistons 130 are received in the respective cylinder bores 101a and each have a tail protruding integrally therefrom into the crank chamber 105. A pair of shoes 132 are arranged in a recess 130a formed in the tail and are disposed into sliding contact with an outer peripheral portion of the swash plate 107 from opposite sides of same. Thus, each piston 130 and the swash plate 107 are interlocked with each other via the shoes 132 such that as the drive shaft 106 rotates, the piston 130 reciprocates in the corresponding cylinder bore 101a.

The rear housing 104 has a suction chamber 140 and a discharge chamber 142 defined therein. The suction chamber 140 can communicate with each cylinder bore 101a through a corresponding suction hole 103a formed through the valve plate 103, and the discharge chamber 142 can communicate with each cylinder bore 101a through a corresponding discharge hole 103b formed through the valve plate 103. The suction and discharge holes 103a and 103b are opened and closed by respective suction and discharge valves, not shown.

A muffler 150 is arranged outside of the cylinder block 101 and has a muffler casing 152 joined through a seal member, not shown, to a muffler base 101b formed integrally with the cylinder block 101. The muffler casing 152 and the muffler base 101b cooperatively define a muffler space 154 therein, and the muffler space 154 communicates with the discharge chamber 142 via a discharge passage 156 extending through the rear housing 104, the valve plate 103 and the muffler base 101b.

A discharge port 152a is formed in the muffler casing 152, and a check valve 200 is arranged in the muffler space 154 in such a manner as to block the communication between the discharge passage 156 and the discharge port 152a. Specifically, the check valve 200 opens/closes depending on the pressure difference between the pressure in the discharge passage 156 and the pressure in the muffler space 154. When the pressure difference is smaller than a predetermined value, the check valve 200 is closed, and when the pressure difference is larger than the predetermined value, the check valve 200 opens.

Accordingly, the discharge chamber 142 can be connected to an outgoing section of the circulation path 12 through the discharge passage 156, the muffler space 154 and the discharge port 152a, and the muffler space 154 is connected with and disconnected from the discharge chamber 142 by the check valve 200. The suction chamber 140, on the other hand, communicates with an incoming or return section of the circulation path 12 through a suction port 104a formed through the rear housing 104.

A displacement control valve (electromagnetic control valve) 300 is accommodated in the rear housing 104 and is inserted in a supply passage 160. The supply passage 160 extends from the rear housing 104 to the cylinder block 101 through the valve plate 103 so as to communicate the discharge chamber 142 with the crank chamber 105.

On the other hand, the suction chamber 140 communicates with the crank chamber 105 through an extraction passage 162. The extraction passage 162 includes gaps between the drive shaft 106 and the bearings 119 and 120, a space 164, and a fixed orifice 103c formed through the valve plate 103.

Also, the suction chamber 140 is connected to the displacement control valve 300, independently of the supply passage 160, through a pressure sensing passage 166 formed in the rear housing 104.

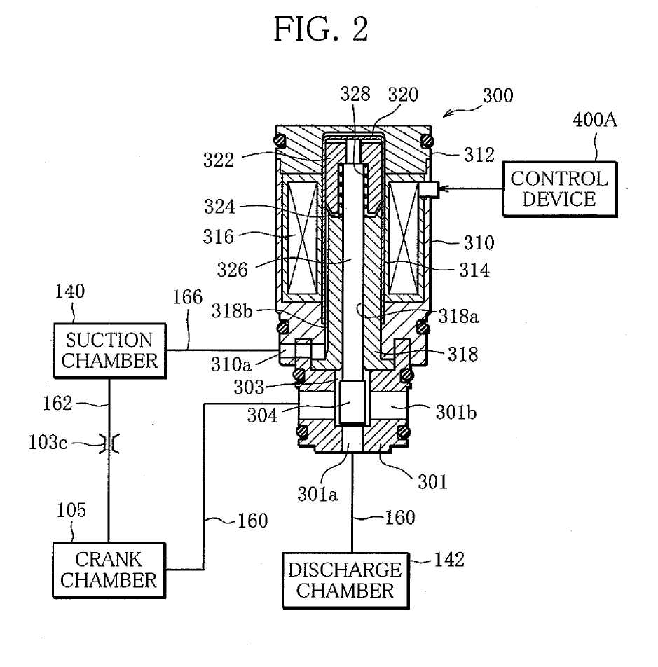

More specifically, as illustrated in FIG. 2, the displacement control valve 300 comprises a valve unit and a drive unit for opening and closing the valve unit. The valve unit includes a cylindrical valve housing 301, and an inlet port (valve opening 301a) is formed at one end of the valve housing 301. The valve opening 301a communicates with the discharge chamber 142 through an upstream section of the supply passage 160 and opens into a valve chamber 303 formed inside the valve housing 301.

A columnar valve element 304 is accommodated in the valve chamber 303. The valve element 304 is movable within the valve chamber 303 in the axial direction of the valve housing 301 and, when brought into contact with an end face of the valve housing 301, closes the valve opening 301a. Namely, the end face of the valve housing 301 serves as a valve seat.

Outlet ports 301b open in the outer peripheral surface of the valve housing 301 and communicate with the crank chamber 105 through a downstream section of the supply passage 160. The outlet ports 301b also open into the valve chamber 303, and thus the discharge chamber 142 and the crank chamber 105 can communicate with each other through the valve opening 301a, the valve chamber 303 and the outlet ports 301b.

The drive unit includes a cylindrical solenoid housing 310 attached to the other end of the valve housing 301 coaxially therewith. The solenoid housing 310 has an open end closed with an end cap 312, and a solenoid 316 wound around a bobbin 314 is accommodated in the solenoid housing 310.

A cylindrical fixed core 318 is also fitted in the solenoid housing 310 coaxially therewith and extends from the valve housing 301 toward the end cap 312 up to a position corresponding to an intermediate portion of the solenoid 316. A portion of the fixed core 318 located close to the end cap 312 is surrounded by a sleeve 320. The sleeve 320 has a closed end corresponding in position to the end cap 312.

The fixed core 318 has an insertion hole 318a formed in the center thereof and having one end opening into the valve chamber 303. A space 324 for accommodating a cylindrical movable core 322 is defined between the fixed core 318 and the closed end of the sleeve 320, and the other end of the insertion hole 318a opens into the movable core accommodation space 324.

A solenoid rod 326 is slidably inserted through the insertion hole 318a, and the valve element 304 is coupled to one end of the solenoid rod 326 integrally and coaxially therewith. The other end of the solenoid rod 326 projects into the movable core accommodation space 324 and is fitted through a through hole formed in the movable core 322 such that the solenoid rod 326 and the movable core 322 act as a one-piece body. A release spring 328 is disposed between the shoulder of the movable core 322 and the end face of the fixed core 318, and a predetermined gap is provided between the movable core 322 and the fixed core 318.

The movable core 322, the fixed core 318, the solenoid housing 310 and the end cap 312 are each made of magnetic material and constitute a magnetic circuit. On the other hand, the sleeve 320 is made of nonmagnetic stainless steel or the like.

The solenoid housing 310 has a pressure sensing port 310a formed therein, and the suction chamber 140 is connected to the pressure sensing port 310a through the pressure sensing passage 166. An axially extending pressure sensing groove 318a is formed in the outer peripheral surface of the fixed core 318 and communicates with the pressure sensing port 310a. Accordingly, the suction chamber 140 and the movable core accommodation space 324 communicate with each other through the pressure sensing port 310a and the pressure sensing groove 318b, so that the pressure in the suction chamber 140 (hereinafter referred to as suction pressure Ps) acts upon the back side of the valve element 304 through the solenoid rod 326 in the valve closing direction.

The displacement control valve 300 is preferably constructed so that a pressure receiving area (hereinafter referred to as seal area Sv) of the valve element 304 on which the pressure in the discharge chamber 142 (hereinafter referred to as discharge pressure Pd) acts when the valve opening 301a is closed by the valve element 304 may be equal to that area of the valve element 304 which is applied with the suction pressure Ps, that is, the cross-sectional area of the solenoid rod 326. The pressure in the crank chamber 105 (hereinafter referred to as crank pressure Pc) acts upon the valve element 304 neither in the valve opening direction nor in the valve closing direction.

The solenoid 316 is connected to a control device 400A provided externally to the compressor 100 and, when supplied with a control current I from the control device 400A, produces an electromagnetic force F(I). The electromagnetic force F(I) exerted by the solenoid 316 attracts the movable core 322 toward the fixed core 318, so that the valve element 304 is urged in the valve closing direction.

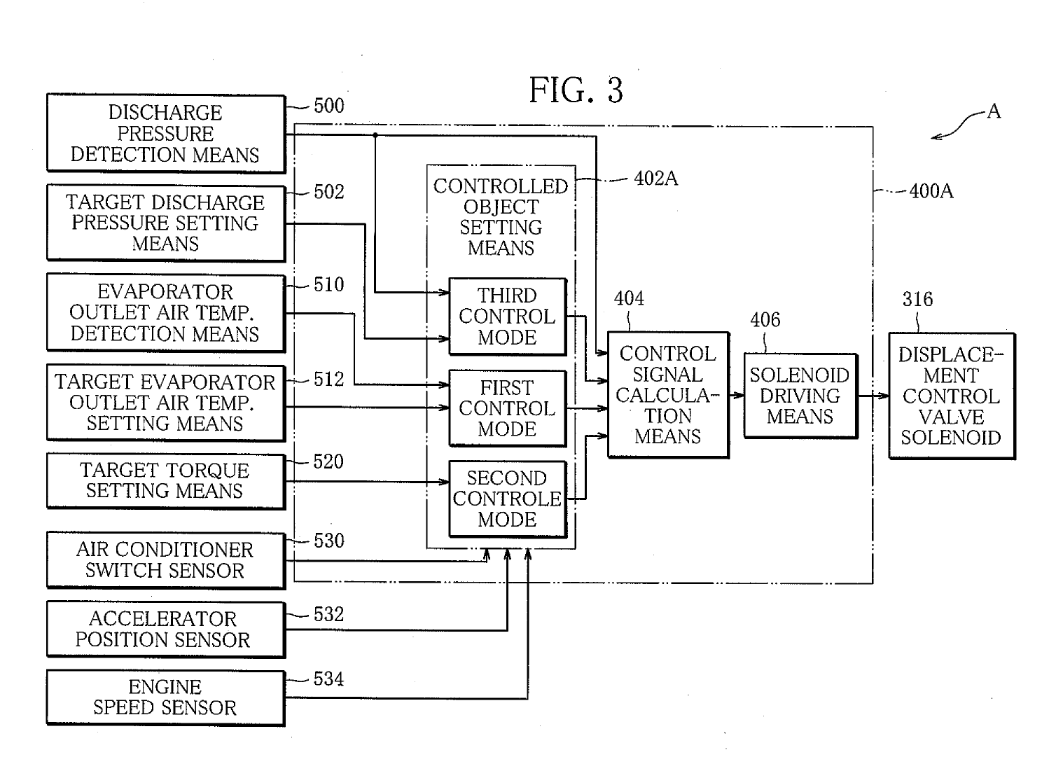

FIG. 3 is a block diagram illustrating a schematic configuration of the displacement control system A including the control device 400A.

The displacement control system A has external information detection means for detecting one or more items of external information. The external information detection means includes discharge pressure detection means 500 and target discharge pressure setting means 502.

The discharge pressure detection means 500 detects the pressure (discharge pressure Pd) of the refrigerant at a suitable portion in a discharge pressure region of the refrigeration cycle 10. For example, the discharge pressure detection means 500 may be a pressure sensor 500a attached to the inlet of the heat radiator 14 to detect the refrigerant pressure at the inlet of the radiator 14 as the discharge pressure Pd, the detected pressure being input to the control device 400A (see FIG. 1).

The target discharge pressure setting means 502 sets a target discharge pressure Pdset2, as a target value for the discharge pressure Pd, and supplies the set target discharge pressure to the control device 400A. The target discharge pressure setting means 502 may be implemented, for example, by part of an air conditioning ECU that controls the operation of the whole air conditioning system.

The discharge pressure region of the refrigeration cycle 10 denotes a region from the discharge chamber 142 to the inlet of the heat radiator 14. A suction pressure region of the refrigeration cycle 10, on the other hand, denotes a region from the outlet of the evaporator 18 to the suction chamber 140. The discharge pressure region also includes the cylinder bores 101a in the compression process, and the suction pressure region also includes the cylinder bores 101a in the suction process.

The external information detection means also includes evaporator outlet air temperature detection means 510 and target evaporator outlet air temperature setting means 512.

The evaporator outlet air temperature detection means 510 detects a temperature Teo of the air flow at the outlet of the evaporator 18 constituting the air circuit of the automotive air conditioning system, and supplies the detected air temperature to the control device 400A. The evaporator outlet air temperature detection means 510 is constituted by a temperature sensor 510a which is attached to the outlet of the evaporator 18 forming part of the air circuit to detect the temperature Teo of the air just left the evaporator 18 (see FIG. 1).

The target evaporator outlet air temperature setting means 512 sets a target value (target evaporator outlet air temperature) Tset for the air temperature Teo at the outlet of the evaporator 18, as a target of discharge displacement control of the compressor 100, on the basis of various external information including vehicle interior temperature setting, and supplies the thus-set target outlet air temperature to the control device 400A.

The target discharge pressure setting means 502 and the target evaporator outlet air temperature setting means 512 may be implemented, for example, by part of the air conditioning ECU for controlling the operation of the whole air conditioning system.

The external information detection means further includes target torque setting means 520 for setting a target torque Trset, the set target torque being input to the control device 400A. The target torque Trset represents a target value for a torque Tr which is a drive load applied by the compressor 100 during the operation, and is set in accordance with instructions from an engine ECU for controlling the engine 114 or from the air conditioning ECU. The target torque setting means 520 may be implemented, for example, by part of the engine ECU or the air conditioning ECU.

Furthermore, the external information detection means includes an air conditioner (A/C) switch sensor 530, an accelerator position sensor 532, and an engine speed sensor 534.

The air conditioner (A/C) switch sensor 530 detects the on/off state of the power switch of the air conditioning system (refrigeration cycle 10) and supplies the detected state to the control device 400A. The accelerator position sensor 532 detects an amount of an accelerator position of the vehicle and supplies the detected operation amount to the control device 400A. The engine speed sensor 534 detects the rotational speed of the engine 114 and supplies the detected speed to the control device 400A.

The control device 400A is constituted, for example, by an independent ECU (Electronic Control Unit) but may be included in the air conditioning ECU or the engine ECU. Also, the target discharge pressure setting means 502, the evaporator outlet air temperature detection means 510, the target evaporator outlet air temperature setting means 512 and the target torque setting means 520 may be included in the control device 400A.

The control device 400A comprises controlled object setting means 402A, control signal calculation means 404, and solenoid driving means 406.

The controlled object setting means 402A is configured to set a controlled object to be controlled, in accordance with two or more control modes. Specifically, the controlled object setting means 402A selects one of the control modes in accordance with the external information acquired by the external information detection means, and sets the controlled object matching the selected control mode. In this embodiment, the controlled object setting means 402A executes first, second and third control modes.

With respect to the controlled object set by the controlled object setting means 402A, the control signal calculation means 404 calculates a discharge displacement control signal in accordance with a predetermined computing equation. The discharge displacement control signal is a signal for adjusting the current (control current I) supplied to the solenoid 316 of the displacement control valve 300 by the solenoid driving means 406 and directly corresponds, for example, to the current value of the control current I supplied to the solenoid 316. Where the solenoid driving means 406 is configured to adjust the control current I by varying the duty ratio through PWM (Pulse Width Modulation) of a predetermined drive frequency (e.g., 400 to 500 Hz), however, the discharge displacement control signal may be a signal corresponding to the duty ratio.

The solenoid driving means 406 supplies the solenoid 316 of the displacement control valve 300 with the control current I or the current with the duty ratio calculated by the control signal calculation means 404. Where the duty ratio is varied through the PWM, the solenoid driving means 406 performs feedback control by detecting the current flowing through the solenoid 316 and varying the duty ratio so that the detected current may become equal to the control current value I calculated by the control signal calculation means 404.

The controlled object setting means 402A selects the control mode in accordance with one or more of the discharge pressure Pd, vehicle driving condition, and heat load both the inside and outside of the vehicle as the external information, for example.

The controlled object selected in the first control mode is the suction pressure Ps. In the first control mode, a target suction pressure Psset is set as a target value for the suction pressure Ps. Specifically, in the first control mode, the target suction pressure Psset is set in accordance with a deviation ΔT between the evaporator outlet air temperature Teo actually detected by the evaporator outlet air temperature detection means 510 and the target evaporator outlet air temperature Tset set by the target outlet air temperature setting means 512.

The controlled object selected in the second control mode is the difference (working pressure difference ΔPw) between the discharge pressure Pd and the suction pressure Ps. In the second control mode, a target working pressure difference ΔPwset is set as a target value for the working pressure difference ΔPw. Specifically, the target working pressure difference ΔPwset is calculated on the basis of the target torque Trset, which is the target value for the torque Tr of the variable displacement compressor 100.

The controlled object selected in the third control mode is the discharge pressure Pd. In the third control mode, the target discharge pressure Pdset2 is set as a target value for the discharge pressure Pd.

Namely, the displacement control system A controls the discharge displacement according to the suction pressure control scheme when the first control mode is executed by the controlled object setting means 402A, and controls the discharge displacement according to the differential pressure control scheme when the second control mode is executed.

The following describes the operation (manner of use) of the displacement control system A.

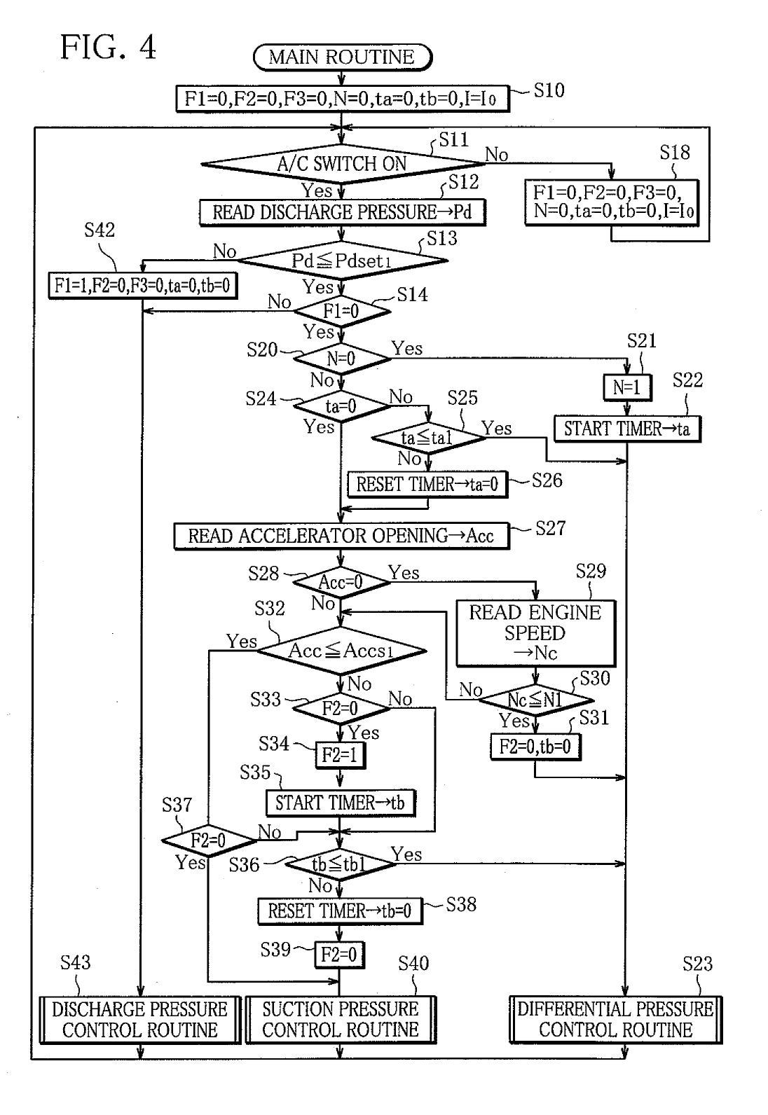

FIG. 4 is a flowchart illustrating a main routine of a program executed by the control device 400A. The main routine is started when the engine key of the vehicle is turned on, and is terminated when the engine key is turned off, for example.

Upon start of the main routine, initial conditions are set first (S10). Specifically, flags F1, F2, F3 and N and elapsed times to and tb are set to zero. Also, the control current I supplied to the solenoid 316 of the displacement control valve 300 is set to I₀ with which the compressor 100 provides a minimum discharge displacement. The current value I₀ may be zero.

It is then determined whether or not the air conditioner (A/C) switch of the automotive air conditioning system is on (S11). Namely, a determination is made as to whether or not cooling/dehumidification of the vehicle compartment is being required by the occupant of the vehicle. If the air conditioner switch is on (Yes), the discharge pressure Pd detected by the discharge pressure detection means 500 is read (S12).

Subsequently, the read discharge pressure Pd is compared with a preset discharge pressure upper-limit value Pdset1 (S13). If the discharge pressure Pd is smaller than or equal to the discharge pressure upper-limit value Pdset1 (Yes), it is determined whether or not the flag F1 is equal to “0” (S14).

The flag F1 has been set to “0” as the initial condition, and therefore, the result of the decision is Yes. Accordingly, a determination is then made as to whether or not the flag N is equal to “0” (S20). Since the flag N has been set to the initial value “0”, the result of the decision is Yes, whereupon the flag N is set to “1” (S21) and a timer is started to measure the elapsed time ta (S22). Subsequently, a differential pressure control routine S23 is executed.

After executing the differential pressure control routine S23, the flow returns to S11 and, if the results of the decisions in S11, S13 and S14 are all Yes, proceeds to S20. Since the flag N has previously been set to “1”, the result of the decision in S20 is No, and thus it is determined whether or not the elapsed time ta is equal to “0” (S24). The timer has already been started in S22. Accordingly, the elapsed time ta is not equal to “0” and the result of the decision is No.

It is then determined whether or not the elapsed time ta is shorter than or equal to a predetermined time ta1 (S25), and if the result of the decision is Yes, the differential pressure control routine S23 is again executed. Namely, the differential pressure control routine S23 is repeatedly executed until the predetermined time ta1 elapses after the air conditioner switch is turned on.

If the predetermined time ta1 is exceeded by the elapsed time ta and thus the result of the decision in S25 is No, that is, if the timer has expired, the timer is stopped and the elapsed time ta is reset to “0” (S26). Then, the amount of the accelerator opening is read as an accelerator opening Acc (S27), and it is determined whether or not the accelerator opening Acc is equal to “0” (S28). If the result of the decision is Yes, the engine speed is read as Nc (S29).

Subsequently, it is determined whether or not the engine speed Nc assumes a value smaller than or equal to a predetermined rotational speed N1 (S30). If the result of the decision is Yes, the flag F2 and the elapsed time tb are both set to “0” (S31), and the differential pressure control routine S23 is executed. The rotational speed N1 is set to a value equivalent to or slightly larger than the idling speed, so that the result of the decision (idling discrimination) in S30 is. Yes when the vehicle is in an idling state. Namely, while the vehicle is in an idling state, the differential pressure control routine S23 is executed.

If the result of the decision in S30 is No, that is, if the vehicle is not in an idling state, a determination is made as to whether or not the accelerator opening Acc assumes a value smaller than or equal to a predetermined opening Accs1 (S32). If the result of the decision is No, it is determined whether or not the flag F2 is equal to “0” (S33). If the result of the decision is Yes, the flag F2 is set to “1” (S34), and a timer is started to measure the elapsed time tb (S35).

After the timer is started in S35, it is determined whether or not the elapsed time tb shows a time shorter than or equal to a predetermined time tb1 (S36). If the result of the decision is Yes, the differential pressure control routine S23 is executed.

Following the execution of the differential pressure control routine S23, Step S11 and the subsequent steps are executed and the decision of S32 is made again. If the result of the decision in S32 is Yes, it is then determined whether or not the flag F2 is equal to zero (S37). Since the flag F2 has previously been set to “1” in S34, the result of the decision in S37 is No, and the decision of S36 is made again. Namely, the differential pressure control routine S23 is repeatedly executed until the predetermined time tb1 is exceeded by the elapsed time tb, that is, until the timer expires.

On the other hand, if the predetermined time tb1 is exceeded by the elapsed time tb, the result of the decision in S36 becomes No, whereupon the timer is stopped and the elapsed time tb is reset to “0” (S38). Also, the flag F2 is set to “0” (S39), followed by the execution of a suction pressure control routine S40. The suction pressure control routine S40 is executed also when the result of the decision in 537 is Yes.

If the result of the decision in S33 is No, Steps S34 and S35 are skipped and Step S36 is executed.

On the other hand, if the result of the decision in S13 is No, that is, if the discharge pressure Pd is higher than the discharge pressure upper-limit value Pdset1, the flag F1 is set to “1” while the flags F2 and F3 and the elapsed times ta and tb are set to “0” (S42). Then, a discharge pressure control routine (protection control) S43 is executed. Namely, when the discharge pressure Pd is higher than the discharge pressure upper-limit value Pdset1, the discharge pressure control routine S43 is executed preferentially over the suction pressure control routine S40 and the differential pressure control routine S23.

If the air conditioner switch is turned off and thus the result of the decision in S11 becomes No, the flags F1, F2, F3 and N, the elapsed times ta and tb and the control current I are all reset (S18).

As described above, the displacement control system A of the first embodiment is configured to selectively execute one of the suction pressure control routine S40, the differential pressure control routine S23 and the discharge pressure control routine S43.

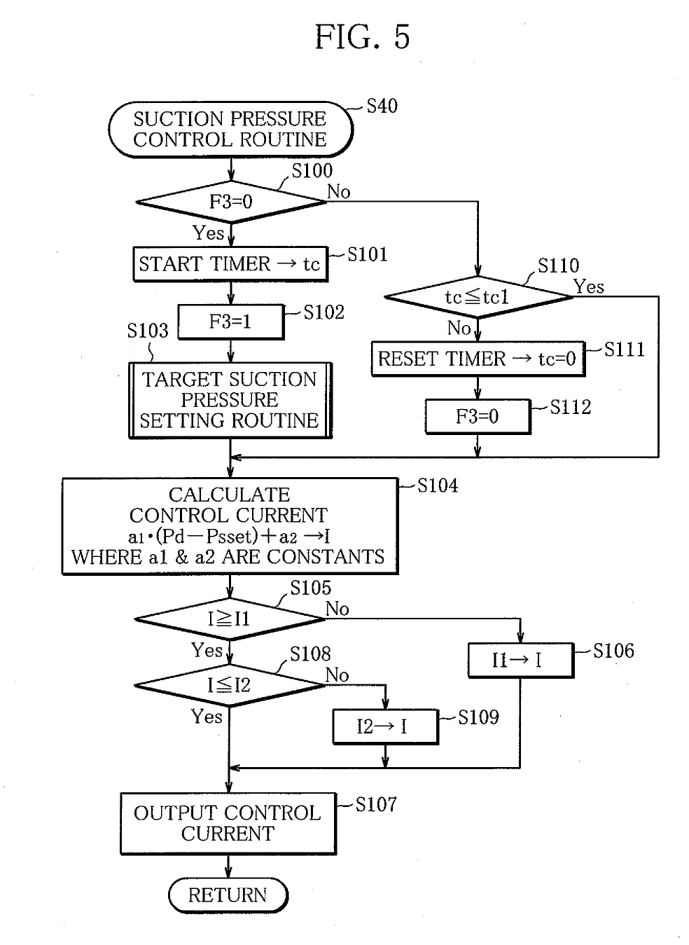

FIG. 5 is a flowchart illustrating details of the suction pressure control routine S40 shown in FIG. 4. In the suction pressure control routine S40, first, it is determined whether or not the flag F3 is equal to “0” (S100). Since the flag F3 has been set to “0” as the initial condition, the result of the decision is Yes. Thus, a timer is started to measure an elapsed time tc (S101), and the flag F3 is set to “1” (S102).

Then, in a target suction pressure setting routine S103, the target suction pressure Psset is set as a control target. Subsequently, using the target suction pressure Psset set in S103 and the discharge pressure Pd detected by the discharge pressure detection means 500, the control current I to be supplied to the solenoid 316 is calculated according to a predetermined computing equation (S104). For example, as illustrated in FIG. 5, the control current I is calculated by multiplying the difference between the discharge pressure Pd and the target suction pressure Psset by a proportional constant a1 and then adding a constant a2 to the product obtained.

The control current I calculated in 5104 is compared with a preset lower-limit value I1 (S105). If it is found as a result of the decision in 5105 that the calculated control current I is smaller than the lower-limit value I1 (No), the lower-limit value I1 is read as the control current value I (S106), and the control current I is output to the solenoid 316 (S107).

On the other hand, if it is found as a result of the decision in 5105 that the calculated control current I is larger than or equal to the lower-limit value I1 (Yes), the control current I is then compared with a preset upper-limit value I2 larger than the lower-limit value I1 (S108).

If, as a result of the decision in S108, the control current value I is found to be larger than the upper-limit value I2 (No), the upper-limit value I2 is read as the control current I (S109), and the control current I is output to the solenoid 316 (S107).

Accordingly, if it is found as a result of the decisions in 5105 and 5106 that the relationship I1≦I≦I2 is fulfilled, the control current I calculated in S104 is directly output to the solenoid 316 (S107).

After Step 5107 is executed, the flow returns from the suction pressure control routine S40 to the main routine, and the discharge pressure Pd detected again by the discharge pressure detection means 500 is read in S12. Then, if the results of the decisions in S13 and S14 are both Yes, the suction pressure control routine S40 is executed again.

When the suction pressure control routine S40 is executed the second time, the result of the decision in S100 is No because the flag F3 has been set to “1” in S102, and therefore, it is determined whether or not the elapsed time tc measured by the timer has reached a predetermined time tc1 (S110). If it is judged as a result of the decision in S110 that the predetermined time tc1 has not elapsed yet from the start of the timer (Yes), the control current I is calculated from the target suction pressure Psset previously set in S103 and the discharge pressure Pd read anew in S12 (S104). The flow thereafter proceeds to S107, as in the first execution of this routine, and then returns to the main routine.

On the other hand, if the predetermined time tc1 is exceeded by the elapsed time tc measured by the timer, the result of the decision in S110 becomes No, whereupon the timer is reset (S111) and the flag F3 is set to “0” (S112). Namely, the target suction pressure Psset is updated at intervals of the predetermined time tc1. The predetermined time tc1 as the updating interval is set, for example, to 5 seconds.

Thus, the discharge pressure Pd is read at all times, and in the suction pressure control routine S40, the control current I is calculated/adjusted so as to match the varying discharge pressure Pd, while the target suction pressure Psset is updated at intervals of the predetermined time tc1.

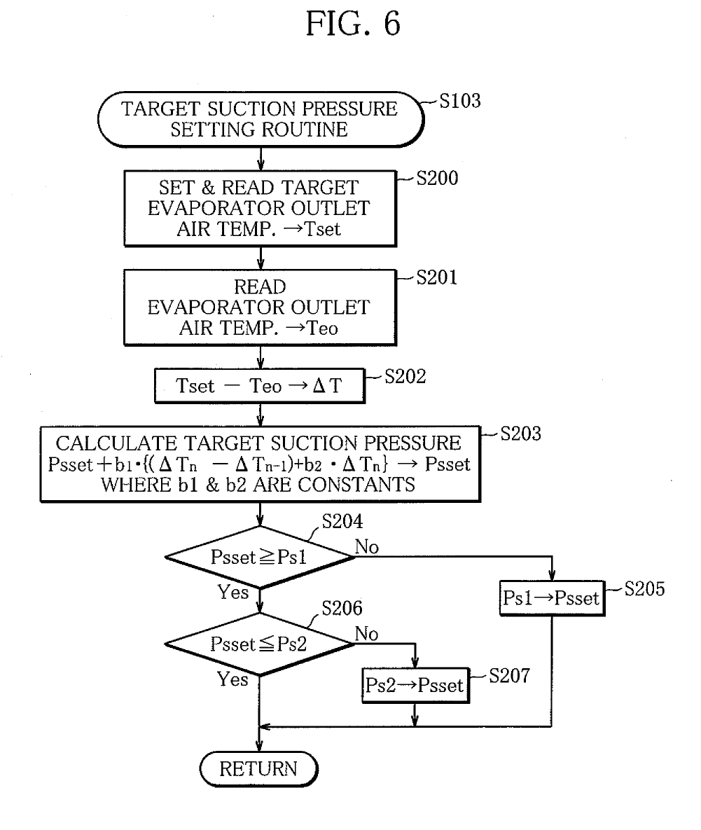

FIG. 6 is a flowchart illustrating details of the target suction pressure setting routine S103 shown in FIG. 5. The target suction pressure setting routine 5103 corresponds to the first control mode of the controlled object setting means 402A.

In the target suction pressure setting routine S103, first, the target evaporator outlet air temperature Tset is set and read as a target of the discharge displacement control for the compressor 100 (S200). Subsequently, the evaporator outlet air temperature Teo detected by the evaporator outlet air temperature detection means 510 is read (S201), and a deviation AT between the target evaporator outlet air temperature Tset set by the target evaporator outlet air temperature setting means 512 and the actual evaporator outlet air temperature Teo detected by the evaporator outlet air temperature detection means 510 is calculated (S202). Then, using the calculated deviation ΔT, the target suction pressure Psset is calculated according to a predetermined computing equation for PI control, for example (S203).

The computing equation illustrated in Step S203 includes the target suction pressure Psset, and an initial value of the target suction pressure Psset is set using an ambient temperature Tamb, for example, according to the following equation:

Psset=K1·Tamb+K2 (K1 and K2 are constants)

Also, each time the target suction pressure setting routine S103 is executed, the deviation ΔT is calculated in S202. Thus, in the computing equation in S203, the subscript “n” suffixed to “ΔT” indicates that ΔT is the deviation calculated in 5202 of the present cycle. Similarly, the subscript “n-1” indicates that ΔT is the deviation calculated in S202 of the preceding cycle.

Subsequently, the calculated target suction pressure Psset is compared with a preset lower-limit value Ps1 (S204). If No in Step S204, the lower-limit value Ps1 is read as the target suction pressure Psset (S205).

If the result of the decision in S204 is Yes, on the other hand, Psset is compared with a preset upper-limit value Ps2 larger than Ps1 (S206). If No in Step S206, the upper-limit value Ps2 is read as the target suction pressure Psset (S207).

Accordingly, if it is found as a result of the decisions in S204 and S206 that the relationship Ps1≦Psset≦Ps2 is fulfilled, the target suction pressure Psset calculated in S203 is directly read as the target suction pressure Psset.

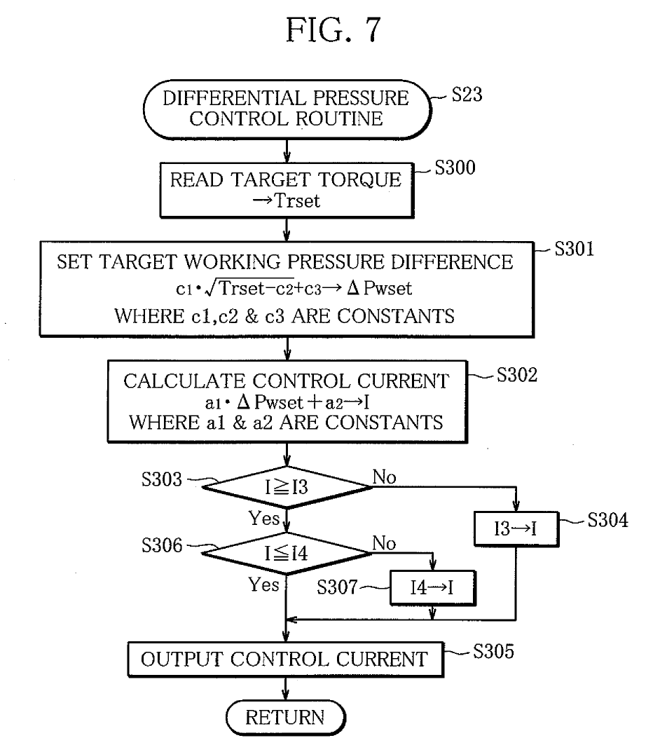

FIG. 7 illustrates details of the differential pressure control routine S23 shown in FIG. 4. In the differential pressure control routine S23, the controlled object setting means 402A executes the second control mode to set the target working pressure difference ΔPwset. The target working pressure difference ΔPwset is a target for the working pressure difference ΔPw, which is the difference (Pd−Ps) between the discharge pressure Pd and the suction pressure Ps.

Specifically, the controlled object setting means 402A reads the target torque Trset set by the target torque setting means 520 (S300) and, based on the target torque Trset, calculates the target working pressure difference ΔPwset according to a predetermined computing equation (S301). The computing equation used is: ΔPwset=c1·Trset−c2)^{0.5}⇄c3, where c1, c2 and c3 are constants. The torque Tr is correlated with the working pressure difference ΔPw, and therefore, the target working pressure difference ΔPwset can be set based on the target torque Trset.

Then, using the thus-set target working pressure difference ΔPwset, the control current I to be supplied to the solenoid 316 is calculated according to a predetermined computing equation (S302). For example, the control current I is calculated by multiplying the target working pressure difference ΔPwset by the proportional constant a1 and then adding the constant a2 to the product obtained.

The control current I calculated in 5302 is compared with a preset lower-limit value I3 (S303). If it is found as a result of the decision in S303 that the calculated control current I is smaller than the lower-limit value I3 (No), the lower-limit value I3 is read as the control current value I (S304), and the control current I is output to the solenoid 316 (S305).

On the other hand, if it is judged as a result of the decision in S303 that the calculated control current I is larger than or equal to the lower-limit value I3 (Yes), the calculated control current I is compared with a preset upper-limit value I4 larger than the lower-limit value I3 (S306). If the result of the decision in S306 indicates that the control current value I is larger than the upper-limit value I4 (No), the upper-limit value I4 is read as the control current I (S307), and the control current I is output to the solenoid 316 (S305).

Thus, if it is found as a result of the decisions in S303 and 5306 that the relationship I3≦I≦I4 is fulfilled, the control current I calculated in S302 is directly output to the solenoid 316 (S305).

As explained above, in the differential pressure control routine S23, the target working pressure difference ΔPwset is set on the basis of the target torque Trset, and using the target working pressure difference ΔPwset, the control current I is calculated. Thus, in the differential pressure control routine S23, the discharge displacement of the compressor 100 is controlled such that the torque Tr of the compressor approaches the target torque Trset.

Namely, the differential pressure control routine S23 permits the torque Tr of the compressor 100 to be adjusted in accordance with driving conditions and the like of the vehicle and serves to ensure the traveling performance of the vehicle and also to stabilize the engine control while maintaining a certain level of air conditioning capacity.

Also, the displacement control system A is configured to select and execute the differential pressure control routine S23 at the start of the automotive air conditioning system or during the idling or acceleration of the vehicle, for example. In this case, the target torque setting means 520 may set a different target torque Trset depending on the applicable situation. In other words, the target torque setting means 520 may be configured to set the target torque Trset in accordance with a mode selected from among a start mode, an idling mode and an acceleration mode.

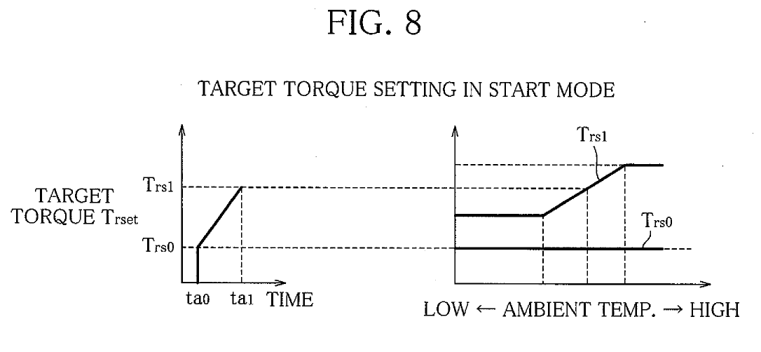

More specifically, in the start mode selected when the air conditioning system is started, the target torque Trset is set in the manner illustrated in the left-hand graph of FIG. 8. When the air conditioner switch is turned on (t=ta0), the target torque Trset is set to a startup initial target torque Trs0 and, as time elapses, is gradually increased up to a post-startup target torque Trs1.

The post-startup target torque Trs1 is set to be larger than the startup initial target torque Trs0. Also, the post-startup target torque Trs1 may be set in such a manner as illustrated in the right-hand graph of FIG. 8 that the post-startup target torque Trs1 lowers with decrease in the ambient temperature, that is, the former rises with increase in the latter.

Thus, at the start of the compressor 100, the torque Tr of the compressor is appropriately adjusted in the start mode, whereby the engine control is stabilized.

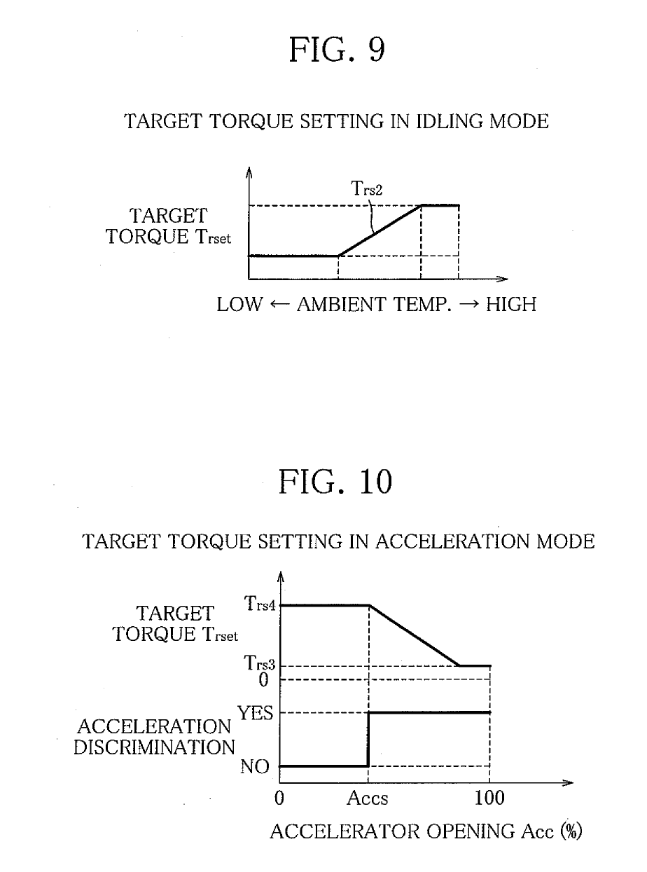

In the idling mode selected during the idling of the vehicle, the target torque Trset is set to an idling target torque Trs2. As illustrated in FIG. 9, the idling target torque Trs2 may also be set so as to lower with decrease in the ambient temperature and rise with increase in the ambient temperature.

The idling mode serves to stabilize the engine speed while the vehicle is in an idling state.

The vehicle is judged to be in an idling state when it is determined that the accelerator opening Acc is “0” in S28 of the main routine and also that the engine speed Nc is lower than or equal to the predetermined speed N1 in S30. Also while the vehicle is traveling at low speed because of congestion, the vehicle may be judged to be in an idling state.

The means for determining the idling state of the vehicle is not limited to the accelerator position sensor 532 and the engine speed sensor 534, and a sensor for detecting the rotational speed of the compressor 100, vehicle speed sensor, a vehicle stop signal sensor, a gearshift position sensor and the like may be suitably used in combination.

In the acceleration mode selected during the acceleration of the vehicle, the target torque Trset may either be set to a fixed value or be varied depending an the accelerator opening Acc, as illustrated in FIG. 10. Specifically, the target torque Trset may be set to a value variable between first and second acceleration target torques Trs3 and Trs4. In this case, the target torque Trset may be so set as to decrease with increase in the accelerator opening Acc in an accelerator opening range exceeding the predetermined opening Accs1.

The affirmative decision “Yes” as to acceleration, shown in FIG. 10, is made when it is judged in S32 of the main routine that the accelerator opening Acc is larger than the predetermined opening Accs1, and the negative decision “No” is made when it is judged that the accelerator opening Acc is smaller than or equal to the predetermined opening Accs1. Once the affirmative decision “Yes” as to acceleration is made, the acceleration mode is executed until the elapsed time tb is judged to have reached the predetermined time in S36. It is therefore possible that the target torque Trset is set to the second acceleration target torque Trs4 even though the result of the determination as to acceleration is No.

Because of the acceleration mode, the torque Tr of the compressor 100 and thus the load on the engine 114 can reduced during the acceleration of the vehicle, whereby the acceleration performance of the vehicle is improved. Also, continuing the acceleration mode for the predetermined time tb1 after the termination of the acceleration greatly contributes to stabilization of the engine control.

The acceleration mode may be executed when at least one of the accelerator opening and rotational speed of the engine 114 is larger than the corresponding predetermined value. By executing the acceleration mode when the engine speed is higher than the predetermined speed, it is possible to provide improved high-speed performance of the vehicle.

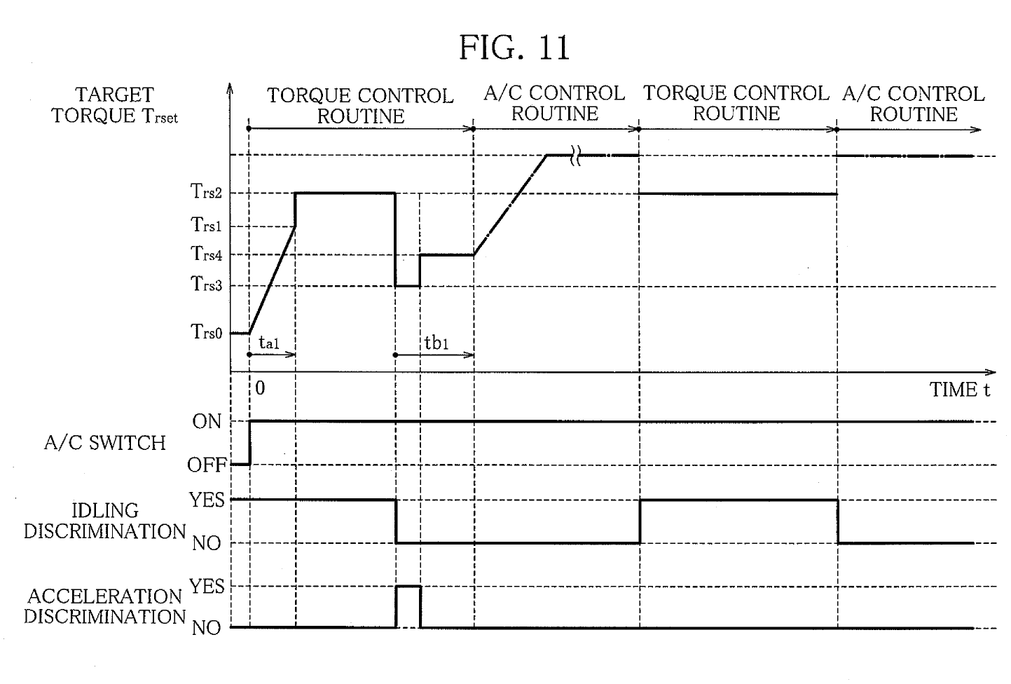

FIG. 11 illustrates an example of how the target torque Trset varies with the lapse of time after the air conditioner switch is turned on. When the air conditioner switch is turned on, the start mode is executed in the differential pressure control routine S23. Accordingly, the target torque Trset is first set to the startup initial target torque Trs0 and then gradually increased such that when the time ta1 has elapsed, the target torque Trset reaches the post-startup target torque Trs1.

If the vehicle is in an idling state when the time ta1 has elapsed, the idling mode is executed in the differential pressure control routine S23. Accordingly, the target torque Trset is set to the idling target torque Trs2.

Then, if the state of the vehicle changes from idling to acceleration and the accelerator opening Acc exceeds the predetermined opening Accs1, the acceleration mode is executed in the differential pressure control routine S23. Thus, the target torque Trset is set to the first acceleration target torque Trs3.

If the accelerator opening Acc becomes smaller than or equal to the predetermined opening Accs1 thereafter, the acceleration mode is continuously executed until the predetermined time tb1 elapses. Where the target torque Trset is set in the acceleration mode so as to vary depending on the accelerator opening Acc as illustrated in FIG. 10, the target torque Trset remains set at the second acceleration target torque Trs4 until the time tb1 elapses after the accelerator opening Acc becomes smaller than or equal to the predetermined opening Accs1.

If the vehicle is traveling at a constant speed when the time tb1 has elapsed, the suction pressure control routine S40 is executed. Since the target torque Trset is not set during the execution of the suction pressure control routine S40, variation in the actual torque Tr of the compressor 100 is only schematically illustrated in FIG. 11 by the dot-dash line. The actual torque Tr gradually increases up to a proper value as the target suction pressure Psset is successively corrected by the PI control in S203 of the target suction pressure setting routine S103, and is thereafter kept at the proper value.

If the vehicle is stopped thereafter and the idling starts again, the control routine switches from the suction pressure control routine S40 to the differential pressure control routine S23, and the idling mode is executed in the differential pressure control routine S23. At the time of switching the control routine, the target suction pressure Psset set last in the suction pressure control routine S40 is preferably stored in the controlled object setting means.

Then, if the vehicle is started from the idling state and accelerated to a constant-speed travel, the suction pressure control routine S40 is executed the second time. When the suction pressure control routine S40 is executed the second time, the stored target suction pressure Psset set last in the air conditioning control routine S40 is preferably used in 5203 as the initial value of the target suction pressure Psset. This permits an optimum target suction pressure Psset to be obtained in a short time in a situation where the suction pressure control routine S40 is suspended and thereafter executed again, whereby the comfort of the vehicle compartment can be maintained.

Thus, the target torque Trset, which is a target of the discharge displacement control, is set on the basis of the torque Tr which is the drive load for driving the compressor 100, and the motive power, whereby the target torque Trset can be set so as to meet the demand of the engine 114.

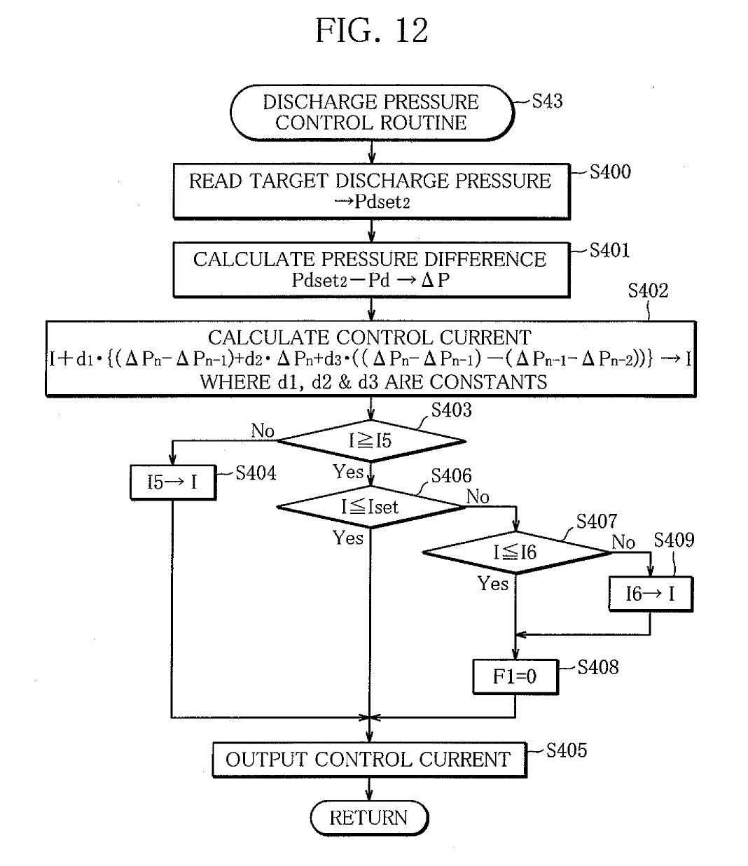

FIG. 12 is a flowchart illustrating details of the discharge pressure control routine S43 shown in FIG. 4.

First, in the discharge pressure control routine S43, the target discharge pressure Pdset2 set by the target discharge pressure setting means 502 is read (S400). The target discharge pressure Pdset2 is lower than the discharge pressure upper-limit value Pdset1 (Pdset2<Pdset1).

Subsequently, a deviation ΔP between the target discharge pressure Pdset2 and the discharge pressure Pd detected by the discharge pressure detection means 500 is calculated (S401). Then, using the deviation ΔP, the control current I to be supplied to the solenoid 316 is calculated according to a predetermined computing equation for PID control, for example (S402).

Each time the discharge pressure control routine S43 is executed, the deviation ΔP is calculated in S401. Thus, in the computing equation illustrated in Step S402, the subscript “n” suffixed to “ΔP” indicates that ΔP is the deviation calculated in S401 of the present cycle. Similarly, the subscript “n-1” indicates that ΔP is the deviation calculated in S401 of the preceding cycle, and the subscript “n-2” indicates that ΔP is the deviation calculated in S401 executed two cycles before.

The control current I calculated in S402 is compared with a preset lower-limit value I5 (S403). If it is found as a result of the decision in S403 that the calculated control current I is smaller than the lower-limit value I5 (No), the lower-limit value I5 is read as the control current I (S404), and the control current I is output (S405). On the other hand, if the result of the decision in S403 is Yes, the calculated control current I is compared with a preset threshold Iset larger than the lower-limit value I5 (S406), and if it is judged as a result of the decision in S406 that the calculated control current I is smaller than or equal to the threshold Iset (Yes), the calculated control current I itself is output to the solenoid 316 (S405).

If the result of the decision in S406 is No, the calculated control current I is compared with an upper-limit value I6 larger than or equal to the threshold Iset (S407). If, as a result of the decision in S407, it is judged that the control current I is smaller than or equal to the upper-limit value I6 (Yes), the flag F1 is set to “0” (S408) and then the control current I is directly output to the solenoid 316 (S405).

On the other hand, if the result of the decision in S407 is No, the upper-limit value I6 is read as the control current I (S409), then the flag F1 is set to “0” (S408), and the control current I is output (S405).

As explained above, in the discharge pressure control routine S43, the deviation ΔP between the target discharge pressure Pdset2 and the discharge pressure Pd detected by the discharge pressure detection means 500 is calculated, and based on the deviation ΔP, the control current I is corrected to control the discharge displacement such that the discharge pressure Pd approaches the target discharge pressure Pdset2.

The threshold Iset serves as a condition for canceling the discharge pressure control routine S43, and where Iset=I6, for example, it is possible to minimize the occurrence of a situation where the control routine again returns to the discharge pressure control routine S43 immediately after the switchover from the discharge pressure control routine S43 to the suction pressure control routine S40.

In the displacement control system A of the first embodiment, the controlled object setting means 402A selectively executes one of the first, second and third control modes in accordance with the external information. The displacement control system A performs the suction pressure control in the first control mode, performs the differential pressure control in the second control mode, and performs the discharge pressure control in the third control mode.

With the displacement control system A, therefore, the discharge displacement can be optimized by switching the control scheme in accordance with various conditions.

Specifically, during the normal operation, the displacement control system A controls the discharge displacement according to the suction pressure control scheme, in order that the vehicle compartment may be properly air-conditioned to ensure comfort. When transitional control is required such as during the acceleration or hill-climbing of the vehicle, the discharge displacement is controlled according to the differential pressure control scheme so that the torque control of the variable displacement compressor 100 may be preferentially executed. By executing the discharge pressure control, it is possible prevent anomalous increase of the discharge pressure Pd, which is the pressure in the discharge pressure region, thereby ensuring the reliability of the variable displacement compressor 100 and of the air conditioning system.

When the first control mode is executed by the controlled object setting means 402A of the displacement control system A, the control signal calculation means 404 calculates the discharge displacement control signal on the basis of the discharge pressure Pd, which is the pressure in the discharge pressure region, and the target suction pressure Psset. Accordingly, the suction pressure control can be executed by means of the displacement control valve 300 with simple construction.

The discharge pressure detection means 500 is conventionally used as an element indispensable for the protection of the variable displacement compressor 100 and the air conditioning system and is not an element newly used in the invention. Accordingly, the construction of the air conditioning system does not become complicated due to the application of the displacement control system A.

In the displacement control system A, the discharge displacement control signal is calculated on the basis of the difference between the discharge pressure Pd and the target suction pressure Psset, and thus the discharge displacement can be reliably controlled such that the suction pressure Ps, which is the pressure in the suction pressure region, approaches the target suction pressure Psset.

During the suction pressure control of the displacement control system A, the discharge displacement is subjected to feedback control such that the temperature Teo of the air just left the evaporator 18 approaches the target evaporator outlet air temperature Tset. This makes it possible to improve the accuracy in controlling the temperature of, for example, a vehicle compartment air-conditioned by the air conditioning system to which the displacement control system A is applied.

The differential pressure control of the displacement control system A permits the torque Tr of the variable displacement compressor 100 to approach the target torque Trset, whereby the displacement control can be executed while ensuring stability of the engine control and traveling performance of the vehicle.

With the displacement control system A, when the air conditioning system which has been stopped until then is operated, the torque Tr of the variable displacement compressor 100 is made to approach the target torque Trset by the differential pressure control, whereby the engine control is stabilized.

Also, the second control mode, namely, the differential pressure control of the displacement control system A is continued for the predetermined time tb1, which serves to stabilize the engine control.

When the vehicle is in an idling state, the displacement control system A permits the torque Tr of the variable displacement compressor 100 to approach the target torque Trset, thereby stabilizing the engine control.

In the displacement control system A, the stored target suction pressure Psset is used to set a new target suction pressure Psset. Thus, where the control mode is switched from the first control mode to the second control mode and then again to the first control mode, the vehicle interior air-conditioned by the air conditioning system can be quickly restored to the previous air-conditioned state of the first control mode.

Also, in the displacement control system A, the upper-and lower-limit values Ps2 and Ps1 are used to restrict the range of the target suction pressure Psset so that the target suction pressure Psset can be set within a proper range. Especially, by using the lower-limit value Ps1 for the target suction pressure Psset, it is possible to set a discharge displacement control point for discriminating shortage of the refrigerant. Namely, while the refrigerant is running short, the discharge displacement can be reliably prevented from being set to the maximum, thereby preventing damage to the compressor 100.

During the execution of the differential pressure control routine S23, the displacement control system A restricts the control current I to the upper-limit value I4 or less, whereby the torque Tr of the variable displacement compressor 100 can be restricted correspondingly by means of the upper-limit value I4.

While the suction pressure control routine S40 is executed, the displacement control system A controls the suction pressure Ps as the controlled object. Thus, when the suction pressure Ps lowers due to shortage of the refrigerant, the discharge displacement is decreased so as to keep the suction pressure Ps at the target suction pressure Psset, and is finally set to the minimum displacement. Consequently, even though the displacement control valve 300 has a simple construction without a pressure-sensitive member such as a bellows used in conventional displacement control valves, it is possible to avoid a situation where the discharge displacement is set to the maximum displacement while the refrigerant is running short, thereby protecting the compressor 100.

With the displacement control system A, the suction pressure control and the differential pressure control can both be executed by using the single displacement control valve 300.

Although the displacement control system A uses the suction pressure Ps as the controlled object, the suction pressure Ps can be controlled over a wide range. The reason is as follows.

In the displacement control valve 300, the forces acting upon the valve element 304 are the discharge pressure Pd, the suction pressure Ps, the electromagnetic force F(I) exerted by the solenoid 316, and the force fs of the release spring 328. The discharge pressure Pd and the force fs of the release spring 328 act in the valve opening direction, while the suction pressure Ps and the electromagnetic force F(I) of the solenoid 316 act in a direction opposite to the valve opening direction, namely, in the valve closing direction.

This relationship is expressed by Equation (1) below, and modifying Equation (1) provides Equation (2). From Equations (1) and (2), it is clear that if the discharge pressure Pd and the electromagnetic force F(I), that is, the control current I, are found, then the suction pressure Ps is determined.

$$\begin{matrix}Sv \cdot ( Pd - Ps ) + fs - F ( I ) = 0 & ( 1 ) \\ Ps = - \frac{1}{Sv} \cdot F ( i ) + Pd + \frac{fs}{Sv} & ( 2 )\end{matrix}$$

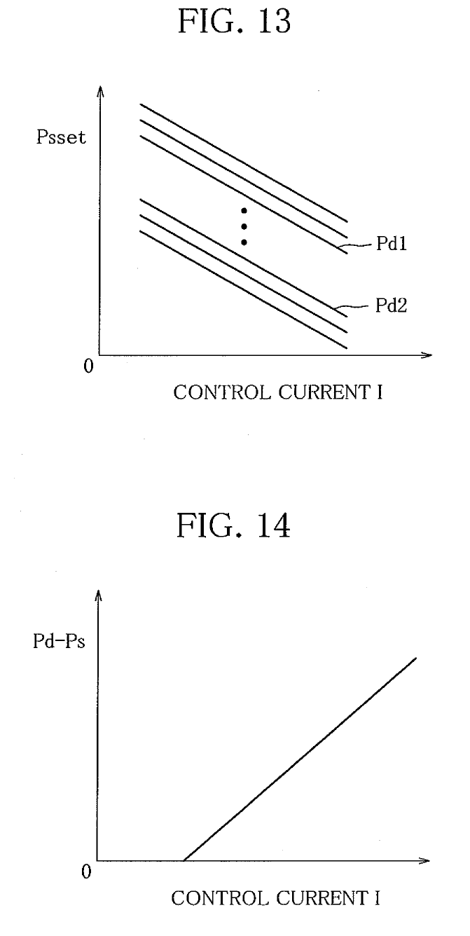

Based on the relationship, the target suction pressure Psset is determined beforehand as illustrated in FIG. 13, whereupon the electromagnetic force F(I) to be produced, namely, the value of the control current I, can be calculated if information on the varying discharge pressure Pd is given. Subsequently, the amount of current supply to the solenoid 316 is adjusted based on the calculated control current I, whereby the valve element 304 is made to operate and thus the crank pressure Pc is adjusted such that the suction pressure Ps approaches the target suction pressure Psset. Namely, the discharge displacement is controlled such that the suction pressure Ps approaches the target suction pressure Psset.

In the case of the control wherein the suction pressure Ps is made to approach the target suction pressure Psset, the control range of the suction pressure Ps is slidable up and down depending on the magnitude of the discharge pressure Pd, as seen from FIG. 13. For example, the control range of the suction pressure Ps for a certain discharge pressure Pd1 is obtained by sliding up, toward a higher pressure side, the control range of the suction pressure Ps for a discharge pressure Pd2 lower than the discharge pressure Pd1.

Equations (1) and (2) also reveal that, by setting the seal area Sv to a smaller value, it is possible to enlarge or widen the control range of the target suction pressure Psset for any discharge pressure Pd even if the electromagnetic force F(I) is small. Where the slidability and expandability of the control range of the target suction pressure Psset are combined, the control range of the target suction pressure Psset can be greatly enlarged by the synergy effect.

The suction pressure Ps can be decreased by increasing the amount of current supplied to the solenoid 316. On the other hand, if the amount of current supply to the solenoid 316 is set to zero, the valve element 304 is forcibly moved away from the valve opening 301a by the force fs of the release spring 328, so that the valve opening 301a opens. Consequently, the refrigerant is introduced from the discharge chamber 142 into the crank chamber 105, and the discharge displacement is kept at the minimum displacement.

Since the displacement control system A provides a wide control range for the suction pressure Ps, the discharge displacement can be reliably controlled even in cases where the suction pressure Ps varies over a wide range depending on the operating conditions of the automotive air conditioning system. For example, even while the heat load is high, a suitable control current I is calculated based on the target suction pressure Psset and the discharge pressure Pd, so that the discharge displacement can be controlled with high reliability.

Also, in the displacement control system A, the seal area (pressure receiving area) Sv of the displacement control valve 300 applied with the discharge pressure Pd can be reduced. Thus, even in the case where the discharge pressure Pd is high, a wide control range is ensured for the suction pressure Ps without the need to increase the size of the solenoid 316.

With the displacement control system A, the control range of the working pressure difference ΔPw (=Pd−Ps) used in the differential pressure control can also be widened by decreasing the seal area Sv, as seen from Equations (1) and (2) and FIG. 14.

Thus, the displacement control system A makes it possible not only to decrease the discharge pressure-receiving area of the valve element 304 of the displacement control valve 300 but also to widen the control range of the suction pressure Ps. Accordingly, even in the case where the displacement control system is applied to an air conditioning system which uses carbon dioxide as the refrigerant and in which the discharge and suction pressures Pd and Ps are both high, the discharge displacement control can be reliably executed without the need to increase the size of the solenoid 316.

Further, in the displacement control system A, when the discharge pressure Pd is higher than the predetermined discharge pressure upper-limit value Pdset1, the control signal calculation means 404 calculates the value of the control current I to be supplied to the solenoid 316 such that the discharge pressure Pd becomes equal to the target discharge pressure Pdset2 lower than the discharge pressure upper-limit value Pdset1. As a result, the discharge pressure Pd is prevented from rising to an abnormal level, ensuring safety of the air conditioning system.

A displacement control system B according to a second embodiment will be now described.

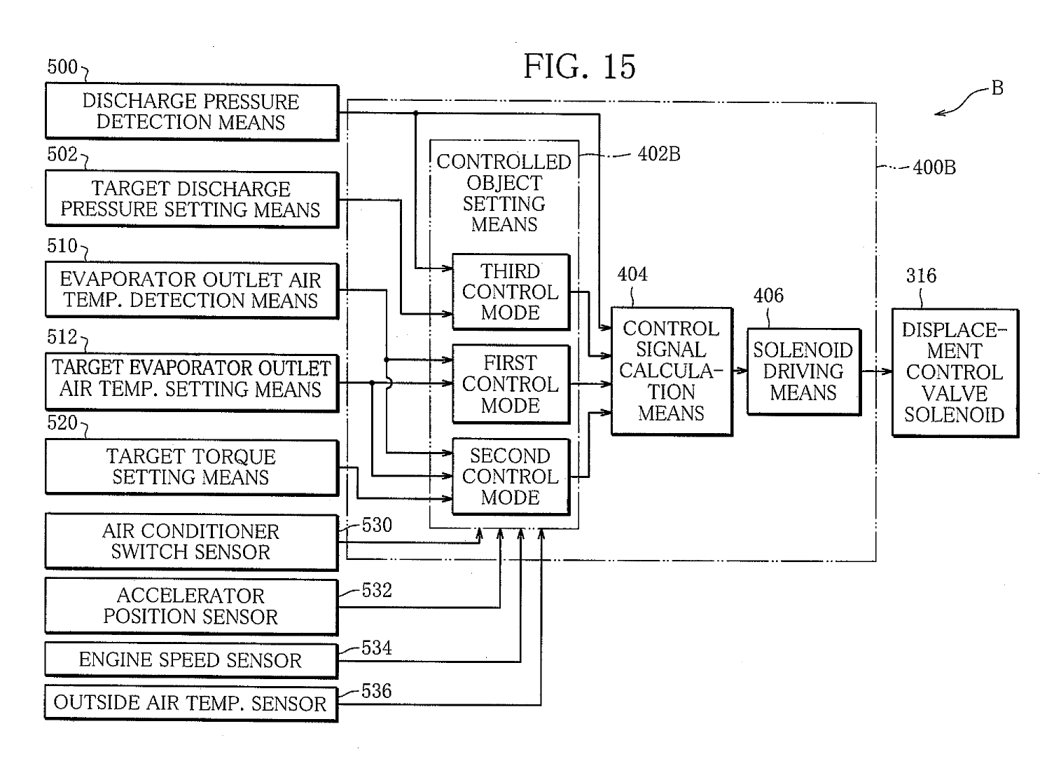

FIG. 15 schematically illustrates the displacement control system B of the second embodiment. The displacement control system B additionally includes, as the external information detection means, means for detecting the heat load between the inside and outside of the vehicle, more specifically, an outside air temperature sensor 536.

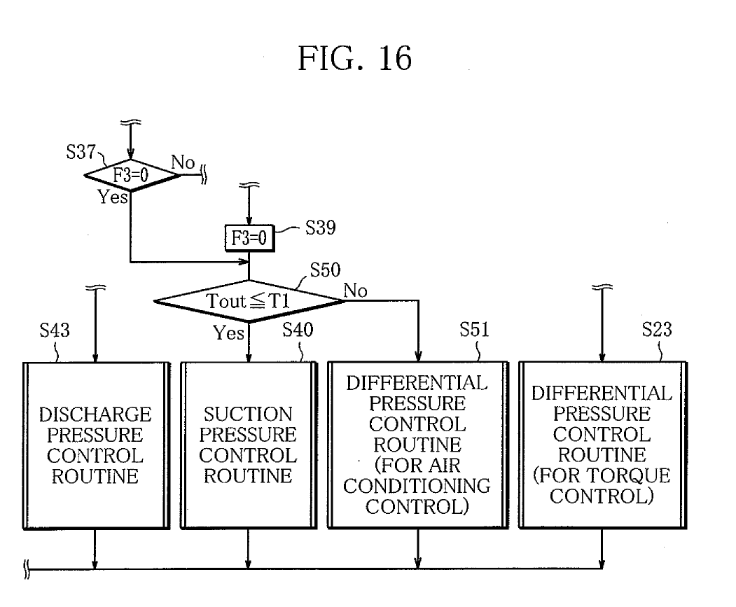

FIG. 16 illustrates part of a main routine executed by the displacement control system B. The remaining part of the main routine executed by the displacement control system B, not illustrated in FIG. 13, is identical with the corresponding part of the main routine executed by the displacement control system A.

In the main routine of the displacement control system B, a determination is made immediately before the suction pressure control routine S40 as to whether or not the temperature of the air outside the vehicle (outside air temperature Tout), detected by the outside air temperature sensor 536, shows a value smaller than or equal to a predetermined upper-limit value T1 (S50). If the outside air temperature Tout is lower than or equal to the upper-limit value T1 (Yes), the suction pressure control routine S40 is executed.

On the other hand, if the outside air temperature Tout is higher than the upper-limit value T1 and thus the result of the decision in S50 is No, a differential pressure control routine S51 is executed. The differential pressure control routine S23 of the first embodiment is primarily aimed at the torque control; the differential pressure control routine S51 of the second embodiment is primarily aimed to preferentially ensure the comfort of the vehicle compartment.

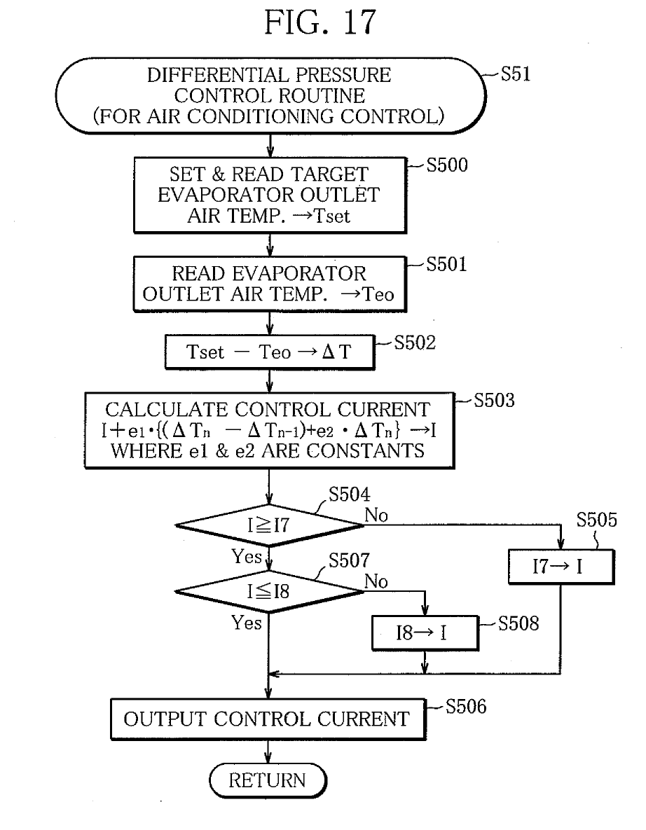

FIG. 17 illustrates details of the differential pressure control routine S51. Steps S500 to S502 of the differential pressure control routine S51 are identical with Steps S200 to S202 of the suction pressure control routine 540. In the differential pressure control routine S51, using the deviation AT calculated in S502, the control current I is calculated according to a predetermined computing equation (S503).

Each time the differential pressure control routine S51 is executed, the deviation ΔT is calculated in S502. Thus, in the computing equation illustrated in 5503, the subscript “n” suffixed to “ΔT” indicates that ΔT is the deviation calculated in S502 of the present cycle. Similarly, the subscript “n-1” indicates that ΔT is the deviation calculated in S502 of the preceding cycle.

The control current I calculated in S503 is then compared with a preset lower-limit value I7 (S504). If it is found as a result of the decision in S504 that the calculated control current I is smaller than the lower-limit value I7 (No), the lower-limit value I7 is read as the control current value I (S505), and the control current I is output to the solenoid 316 (S506).

On the other hand, if it is found as a result of the decision in S504 that the calculated control current I is larger than or equal to the lower-limit value I7 (Yes), the control current I is then compared with a preset upper-limit value I8 larger than the lower-limit value I7 (S507). If, as a result of the decision in S507, the control current value I is found to be larger than the upper-limit value I8 (No), the upper-limit value I2 is read as the control current I (S508), and the control current I is output to the solenoid 316 (S506).

Accordingly, if it is judged as a result of the decisions in S504 and S507 that the relationship 17≦I≦I8 is fulfilled, the control current I calculated in S503 is directly output to the solenoid 316 (S506).

The target working pressure difference ΔPwset is not expressly indicated in the differential pressure control routine S51. However, since the new control current I is set based on the control current I in S503, the target working pressure difference ΔPwset is virtually set in the differential pressure control routine S51 and the working pressure difference ΔPw is controlled so as to approach the target working pressure difference ΔPwset. Consequently, the differential pressure control routine S51 uses the differential pressure control scheme, and it can be said that the second control mode is executed in the differential pressure control routine S51 by the controlled object setting means 402B.

In the displacement control system B of the second embodiment, when the outside air temperature Tout is higher than the upper-limit value T1, it is assumed that the heat load between the inside and outside of the vehicle is larger than a predetermined value, and the controlled object setting means 402B executes the second control mode, instead of the first control mode. In the second control mode, the target working pressure difference ΔPwset is set so that the temperature Teo of the air just left the evaporator 18 may approach the target outlet air temperature Tset. Thus, even in a situation where the outside air temperature Tout as indicative of the heat load is high and thus the heat load on the evaporator 18 is so large that the displacement cannot be controlled by the suction pressure control, the displacement control can be satisfactorily executed by the differential pressure control, making it possible to maintain the comfort of the vehicle compartment air-conditioned by the air conditioning system.

Also, in the displacement control system B, the upper-limit value I8 is provided for restricting the control current I. Accordingly, the variable displacement compressor 100 is prevented from being continuously operated with the maximum discharge displacement in cases where the outside air temperature Tout is extremely high and thus the heat load on the evaporator 18 is high or the circulation amount of the refrigerant is short, whereby the reliability of the variable displacement compressor 100 is ensured.

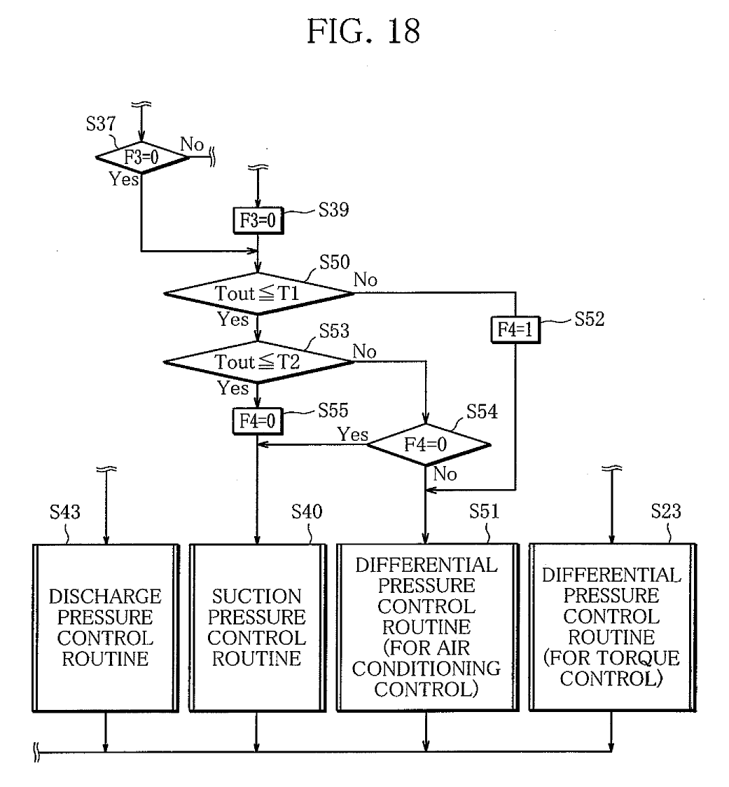

The displacement control system B may alternatively execute the part of the main routine illustrated in FIG. 18. In this case, if the outside air temperature Tout is judged to be higher than the upper-limit value T1, that is, if the result of the decision in S50 is No, a flag F4 is set to “1” (S52) and then the differential pressure control S51 is executed. The flag F4 is additionally used for this main routine.

If, after the execution of the differential pressure control routine S51, the outside air temperature Tout is judged to be lower than or equal to the upper-limit value T1 in S50 (Yes), it is then determined whether or not the outside air temperature Tout shows a value smaller than or equal to a threshold T2 smaller than the upper-limit value T1 (S53). If the outside air temperature Tout is higher than the threshold T2, that is, if the result of the decision is No, it is determined whether or not the flag F4 is equal to “0” (S54). Since the flag F4 has been set to “1”, the result of the decision in S54 is No, and the differential pressure control routine S51 is again executed.

On the other hand, if the outside air temperature Tout is lower than or equal to the threshold T2, that is, if the result of the decision in S53 is Yes, the flag F4 is set to “0” (S55), and then the suction pressure control routine S40 is executed.

Thus, according to the main routine of which the part is illustrated in FIG. 18, the switchover from the suction pressure control routine S40 to the differential pressure control routine S51 takes place when the outside air temperature Tout becomes higher than the upper-limit value T1. On the other hand, the switchover from the differential pressure control routine S51 to the suction pressure control routine S40 takes place when the outside air temperature Tout becomes lower than or equal to the threshold T2.

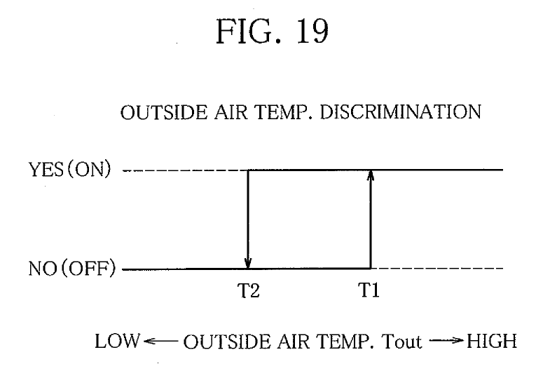

FIG. 19 illustrates the switchover executed on the basis of the outside air temperature Tout. When the result of the outside air temperature discrimination turns to YES (ON), the differential pressure control routine S51 is started, and when the result of the discrimination turns to NO (OFF), the suction pressure control routine S40 is started.

Also, while the engine speed Nc is high, the displacement control system B may execute the differential pressure control routine S51, in place of the differential pressure control routine S23.

The following describes a displacement control system C for a variable displacement compressor according to a third embodiment.

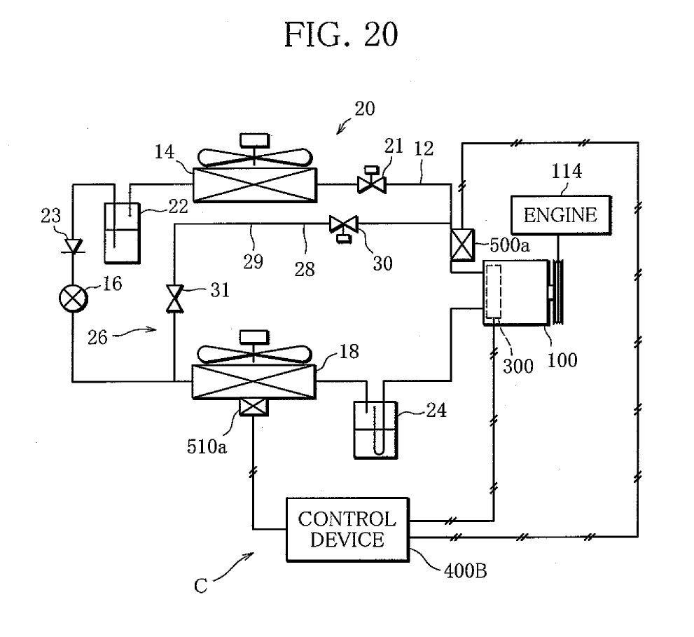

FIG. 20 illustrates a schematic configuration of an automotive air conditioning system to which the displacement control system C is applied. The automotive air conditioning system has a refrigeration cycle 20 with the circulation path 12. In the circulation path 12, the variable displacement compressor 100, a first on-off valve 21, the heat radiator 14, a receiver 22, a check valve 23, the expansion device 16, the evaporator 18 and an accumulator 24 are successively inserted in the mentioned order as viewed in the flowing direction of refrigerant. The expansion device 16 not only serves to expand the refrigerant but is capable of adjusting the circulation amount of the refrigerant in accordance with the degree of superheat of the refrigerant at the outlet of the evaporator 18.

The automotive air conditioning system also has a hot gas heater cycle 26 with a hot gas circulation path 28, and the refrigerant (hot gas) discharged from the variable displacement compressor 100 is circulated through the hot gas circulation path 28. Specifically, the hot gas circulation path 28 is constituted by a bypass 29 connected to the circulation path 12, and part of the circulation path 12.

The bypass 29 connects a portion of the circulation path 12 between the variable displacement compressor 100 and the first on-off valve 21 to a portion of the circulation path 12 between the expansion device 16 and the evaporator 18. A second on-off valve 30 and a fixed constriction 31 are inserted in the bypass 29.

Thus, in the hot gas circulation path 28, the variable displacement compressor 100, the second on-off valve 30, the fixed constriction 31, the evaporator 18 and the accumulator 24 are successively inserted in the mentioned order as viewed in the flowing direction of the hot gas.

The on-off operation of the first and second on-off valves 21 and 30 is controlled, for example, by the air conditioning ECU. When the first on-off valve 21 is open while the second on-off valve 30 is closed, the refrigeration cycle 20 operates so that the vehicle interior can be cooled or dehumidified. Specifically, during the operation of the refrigeration cycle 20, the low-temperature refrigerant in a gas-liquid two-phase state evaporates in the evaporator 18, so that the evaporator 18 functions as a heat exchanger for cooling air.

On the other hand, when the first on-off valve 21 is closed while the second on-off valve 30 is open, the hot gas heater cycle 26 operates so that the vehicle interior can be heated. Specifically, during the operation of the hot gas heater cycle 26, the high-temperature gaseous refrigerant flows through the evaporator 18, so that the evaporator 18 functions as a heat exchanger (auxiliary heating device) for heating air.

The displacement control system C additionally comprises cycle detection means, compared with the displacement control system B illustrated in FIG. 15. The cycle detection means determines which of the refrigeration cycle 20 and the hot gas heater cycle 26 is in operation, and is incorporated in the air conditioning ECU, for example.

The pressure sensor 500a, which serves as the discharge pressure detection means 500, is arranged downstream of the variable displacement compressor 100 and upstream of the first and second on-off valves 21 and 30. In other words, the pressure sensor 500a is arranged in that portion of the discharge pressure region of the circulation path 12 which is shared by the refrigeration cycle 20 and the hot gas heater cycle 26.

While the refrigeration cycle 20 is in operation, the displacement control system C of the third embodiment controls the discharge displacement of the variable displacement compressor 100 in accordance with the main routine illustrated in FIG. 4, 16 or 18, like the displacement control systems A and B.

On the other hand, while the hot gas heater cycle 26 is in operation, the displacement control system C controls the discharge displacement of the variable displacement compressor 100 in accordance with the differential pressure control routine S51 illustrated in FIG. 17. In the differential pressure control routine S51, the discharge displacement is controlled such that the evaporator outlet air temperature Tset approaches the target outlet air temperature Tset.

Needless to say, during the operation of the hot gas heater cycle 26, the target outlet air temperature Tset is set to a value higher than that set during the operation of the refrigeration cycle 20.

Thus, in the displacement control system C of the third embodiment, while the hot gas heater cycle 26 is in operation, the discharge displacement is controlled according to the differential pressure control scheme. Since the controlled object is not suction pressure, the discharge displacement can be optimally controlled in a low-temperature environment requiring heating operation of the air conditioning system, whereby the vehicle interior air-conditioned by the air conditioning system can be kept comfortable.

In the displacement control system C, the discharge displacement is subjected to feedback control such that the temperature Teo of the air just left the air-heating heat exchanger (evaporator 18) approaches the target outlet air temperature Tset. This makes it possible to improve the accuracy in controlling the temperature of the vehicle compartment air-conditioned by the air conditioning system to which the displacement control system C is applied.

Since the discharge pressure detection means 500 is arranged in that portion of the discharge pressure region of the circulation path 12 which is shared by the refrigeration cycle 20 and the hot gas heater cycle 26, the function of the discharge pressure detection means 500 is utilized while either one of the refrigeration cycle 20 and the hot gas heater cycle 26 is in operation. Namely, in the displacement control system C, while the hot gas heater cycle 26 is in operation, anomalous pressure rise of the discharge pressure region can be detected by the discharge pressure detection means 500, and further, the discharge pressure control routine S43 can be executed.

The present invention is not limited to the first to third embodiments described above and may be modified in various ways.

For example, in the first to third embodiments, whether to switch the control routine from the suction pressure control routine S40 to the differential pressure control routine S23 is determined only in the main routine, but the switchover may be effected under other conditions.

When the load on the engine 114 is larger than or equal to a predetermined value, for example, the switchover from the suction pressure control routine S40 to the differential pressure control routine S23 may be carried out. In this case, if the load of the engine 114 becomes greater than or equal to the predetermined value, the torque Tr of the variable displacement compressor 100 can be made to approach the target torque Trset, thus ensuring the traveling performance of the vehicle.

Also, the switchover from the suction pressure control routine S40 to the differential pressure control routine S23 may be effected when the load of the engine 114 and the heat load between the inside and outside of the vehicle are both larger than or equal to respective predetermined values. In this case, unnecessary execution of the differential pressure control routine S23 is prevented, whereby the vehicle interior can be kept comfortably air-conditioned.

Further, an additional condition may be set for the execution of the differential pressure control routine S23. Specifically, the differential pressure control routine S23 may be executed only when the control current I output in S313 of the differential pressure control routine S23 is smaller than the control current I output in S107 of the suction pressure control routine S40. This also prevents unnecessary execution of the differential pressure control routine S23, making it possible to keep the vehicle interior comfortably air-conditioned.

In the second embodiment, whether to switch the control routine from the suction pressure control routine S40 to the differential pressure control routine S51 is determined solely on the basis of the heat load between the inside and outside of the vehicle. Some other condition may also be used to determine the switchover.

For example, when the heat load between the inside and outside of the vehicle and a physical quantity corresponding to the rotational speed of the variable displacement compressor 100 are both larger than or equal to respective predetermined values, the differential pressure control routine S51 may be executed. In this case, even in a situation where the heat load is so high that the discharge displacement cannot be controlled by the suction pressure control, the discharge displacement can be controlled by the differential pressure control, whereby the vehicle compartment air-conditioned by the air conditioning system can be kept comfortable. Also, by executing the differential pressure control routine S51 only when the heat load between the inside and outside of the vehicle and the rotational speed of the variable displacement compressor 100 are both larger than or equal to the respective predetermined values, it is possible to prevent unnecessary execution of the differential pressure control routine S51, whereby the vehicle interior can be kept comfortably air-conditioned.

The physical quantity corresponding to the rotational speed of the variable displacement compressor 100 includes the compressor rotation speed itself.

The first to third embodiments include, as the external information detection means, the discharge pressure detection means, the evaporator outlet air temperature detection means 510, the target evaporator outlet air temperature setting means 512, the target torque setting means 520, the air conditioner switch sensor 530, the accelerator position sensor 532, the engine speed sensor 534, and the outside air temperature sensor 526. The configuration of the external information detection means is not particularly limited and the following sensors may be appropriately used: an outside air humidity sensor, a sensor for detecting the amount of solar radiation, a sensor for detecting the amount of air blown by a fan for the evaporator 18, a sensor for detecting the position of an inside/outside air switching door, an air outlet position sensor, an air mix door position sensor, a vehicle interior temperature sensor, a vehicle interior humidity sensor, an evaporator inlet air temperature sensor, an evaporator inlet air humidity sensor, a temperature or humidity sensor for detecting the extent to which the evaporator is cooled, a sensor for detecting the rotational speed of the variable displacement compressor 100, a vehicle speed sensor, a throttle opening sensor, and a gearshift position sensor.

In the first to third embodiments, the temperature sensor 510a serving as the evaporator outlet air temperature detection means 510 is used for setting the target suction pressure Psset and the target working pressure difference ΔPwset. Instead of using the temperature sensor 510a, a map may be prepared which represents the relationship of the target suction pressure Psset or the target working pressure difference ΔPwset with one or more items of external information obtained by the other external information detection means, and an applicable target suction pressure Psset or target working pressure difference ΔPwset corresponding to the one or more items of external information may be read from the map.

Also, in the first to third embodiments, whether the vehicle is in an idling state or not may be determined on the basis of one or more items of external information selected from the accelerator opening, the throttle opening, the engine speed Nc, the rotational speed of the variable displacement compressor 100, the vehicle speed, and the gearshift position.

In the second embodiment, the heat load between the inside and outside of the vehicle may be determined from one or more items of external information selected from the outside air temperature Tout, the outside air humidity, the discharge pressure Pd, the amount of solar radiation, the ON/OFF state of the air conditioner switch, the air blow amount of the fan for the evaporator 18, the position of the inside/outside air switching door, the air outlet position, the position of the air mix door, the vehicle interior temperature, the vehicle interior humidity, the evaporator inlet air temperature, the evaporator inlet air humidity, and the temperature or humidity indicative of the extent to which the evaporator is cooled.

In the first to third embodiments, the valve element 304 of the displacement control valve 300 is applied with the discharge pressure Pd, which is the pressure of the refrigerant in the discharge chamber 142. The valve element 304 may alternatively be acted upon by the pressure (high pressure) of the refrigerant in a portion of a high-pressure region of the refrigeration cycle 10 or 20.

Also, the valve element 304 of the displacement control valve 300 is acted upon by the suction pressure Ps, which is the pressure of the refrigerant in the suction chamber 140, but may alternatively be applied with the pressure (low pressure) of the refrigerant in a portion of the suction pressure region of the refrigeration cycle 10 or 20.

To simplify the construction of the refrigeration cycle 10 or 20, however, the displacement control valve 300 is preferably built into the compressor 100. Thus, the displacement control valve 300 is usually constructed such that the valve element 304 is applied with the discharge pressure Pd and the suction pressure Ps.

The high-pressure region of the refrigeration cycle 10, 20 denotes a region from the discharge chamber 142 to the inlet of the expansion device 16. The high-pressure region also includes the cylinder bores 101a in the compression process.

In the first to third embodiments, the pressure of the refrigerant at the inlet of the heat radiator 14 is detected as the discharge pressure Pd by the discharge pressure detection means 500. The discharge pressure detection means 500 may alternatively detect the pressure (high pressure) of the refrigerant in a portion of the high-pressure region of the refrigeration cycle 10, 20, instead of the discharge pressure Pd. Namely, the discharge pressure detection means 500 may be high-pressure detection means. In this case, the constructional flexibility of the displacement control systems A and B improves.

In the displacement control systems A to C, the target suction pressure Psset is varied by being subjected to the PI or PID control. Thus, even if there is a deviation between the pressure detected by the discharge pressure detection means 500 and the pressure acting upon the valve element 304 of the displacement control valve 300, the displacement control can be properly executed.

Also, the discharge pressure detection means 500 may detect the discharge pressure Pd in an indirect manner, by first detecting the high pressure and then calculating the discharge pressure Pd by using the detected high pressure. In the first to third embodiments, for example, the pressure sensor 500a and the displacement control valve 300 are located in different positions, and thus, there is a difference between the discharge pressure Pd detected by the pressure sensor 500a and the discharge pressure Pd received by the valve element 304. In order to correct the difference, the value of the discharge pressure Pd detected by the pressure sensor 500a may be multiplied by a correction coefficient, and using the product obtained, the control current I may be calculated.

Further, the discharge pressure detection means 500 may detect the high pressure in an indirect manner. For example, the discharge pressure detection means 500 may include a temperature sensor for detecting the temperature of the refrigerant in a portion of the high-pressure region and may calculate the high pressure by using the detected temperature of the refrigerant in the high-pressure region. Thus, where no particular restrictions are placed on the construction of the discharge pressure detection means 500, the constructional flexibility of the displacement control system improves.

Also, the discharge pressure detection means 500 may be configured to calculate the discharge pressure Pd on the basis of the heat load between the inside and outside of the vehicle, a physical quantity corresponding to the rotational speed of the compressor 100, the voltage applied to a fan which is operated for at least one of the heat radiator 14 and the vehicle's radiator, and the vehicle speed.

In this case, the discharge pressure detection means 500 includes a head load sensor for detecting the heat load, a rotational speed sensor for detecting a physical quantity corresponding to the rotational speed of the compressor 100, a fan voltage sensor for detecting the voltage applied to the fan operated for at least one of the heat radiator 14 and the vehicle's radiator, and a vehicle speed sensor for detecting the speed of the vehicle. Where the high pressure is thus detected in an indirect manner, the constructional flexibility of the air conditioning system improves.

Alternatively, the discharge pressure detection means 500 may detect the high pressure on the basis of the heat load between the inside and outside of the vehicle, the physical quantity corresponding to the rotational speed of the compressor 100, the voltage applied to the fan which is operated for at least one of the heat radiator 14 and the vehicle's radiator, the vehicle speed, and the target pressure Psset set by the controlled object setting means 402A, 402B. Also in this case, the high pressure is detected in an indirect manner, so that the constructional flexibility of the air conditioning system improves.

In the first to third embodiments, the controlled object setting means 402A, 402B sets the target suction pressure Ps as a target value for the suction pressure Ps, but may set a target value for the pressure (low pressure) of the refrigerant in any desired portion of the suction pressure region of the refrigeration cycle 10, 20. In this case, the constructional flexibility of the displacement control systems A to C improves.

The discharge pressure detection means 500 preferably detects the pressure of the refrigerant in a portion of the discharge pressure region of the refrigeration cycle 10, 20, and more desirably, directly or indirectly detects the pressure of the refrigerant in the discharge chamber 142. The controlled object setting means 402A, 402B preferably sets a target value for the pressure of the refrigerant in the suction chamber 140. In this case, the control current I to be supplied to the solenoid 316 is adjusted so as to accurately reflect the discharge and suction pressures Pd and Ps actually received by the valve element 304 of the displacement control valve 300, without regard to fluctuation in the refrigerant pressure in the high-pressure region, so that the accuracy in controlling the suction pressure Ps improves.

In the first to third embodiments, it is not essential for the control device 400A, 400B to execute the discharge pressure control routine S43. In order to protect the variable displacement compressor 100, however, the discharge pressure control routine S43 should preferably be executed.

The main routine executed by the control device 400A, 400B may be additionally provided with an emergency escape control procedure for setting the discharge displacement to the minimum displacement, which is executed preferentially over the discharge pressure control routine S43 when the vehicle is accelerated or the engine speed Nc is higher than a predetermined value, for example.

Also, in the first to third embodiments, the main routine executed by the control device 400A, 400B may additionally include a step of estimating the torque Tr of the variable displacement compressor 100 from the control current I and outputting the estimated torque Tr to the engine ECU, for the purpose of adjusting the load on the engine 114. In this case, the engine ECU is allowed to control the output of the engine 114 on the basis of the estimated torque Tr of the variable displacement compressor 100.

Further, in the first to third embodiments, the lower-and upper-limit values Ps1 and Ps2 for the target suction pressure Psset may be varied in accordance with an output value from the external information detection means such as the heat load detection means, vehicle driving condition detection means or compressor operating condition detection means. By varying the lower- and upper-limit values Ps1 and Ps2 in accordance with the external information, it is possible to set an appropriate target suction pressure Psset matching the external information.

Also, the lower-limit values I1, I3 and I5 and the upper-limit values I2, I4 and I6 for the control current I may be varied in accordance with an output value from the external information detection means such as heat load detection means or the driving condition detection means.

Further, the discharge pressure upper-limit value Pdset1, based on which whether to switch to the discharge pressure control routine S43 is determined, and the target discharge pressure Pdset2 used in the discharge pressure control routine S43 may be varied in accordance with an output value from the external information detection means such as the heat load detection means or the driving condition detection means.

In the target suction pressure setting routine S103 of the first to third embodiments, the target suction pressure Psset is calculated according to the predetermined computing equation by using the deviation ΔT between the target evaporator outlet air temperature Tset set by the target evaporator outlet air temperature setting means 512 and the actual evaporator outlet air temperature Teo detected by the evaporator outlet air temperature detection means 510. The method of setting the target suction pressure Psset is, however, not limited to this method only.

Also, the aforementioned various computing equations are not limited to those illustrated and explained with reference to the first to third embodiments. For example, the control current computing equation (S104) used in the suction pressure control routine S40 of FIG. 5 may be replaced by: a·Pd−b·Psset+c (where a, b and c are constants), and also the term (Pd−Psset)ⁿ may be included to make the equation nonlinear.

For Step 5203 in the target suction pressure setting routine 5103 illustrated in FIG. 6, any desired computing equation may be used insofar as the target suction pressure Psset is calculated so that the evaporator outlet air temperature Teo may approach the target evaporator outlet air temperature Tset.

In the differential pressure control routine S23 illustrated in FIG. 7, the rotational speed of the compressor 100 and the heat load may be added, as variables, to the computing equation used in Step 5301, or the constants c1, c2 and c3 may be varied in accordance with the rotational speed of the compressor 100 and the heat load.

For Step S402 in the discharge pressure control routine S43 illustrated in FIG. 12, any desired computing equation may be used insofar as the control current I is calculated so that the discharge pressure Pd may approach the target discharge pressure Pdset2.

Also, in Step S502 of the discharge pressure control routine S51 of FIG. 17, any desired computing equation may be used insofar as the target suction pressure Psset is calculated so that the evaporator outlet air temperature Teo may approach the target evaporator outlet air temperature Tset.

In the first to third embodiments, the amount of current supplied to the solenoid 316 is detected by the solenoid driving means 406. It is not essential, however, for the solenoid driving means 406 to detect the amount of current supply to the solenoid 316. The control signal calculation means 404 may be configured to directly calculate a duty ratio as the discharge displacement control signal, and the solenoid driving means 406 may be configured to supply current to the solenoid 316 in the duty ratio calculated by the control signal calculation means 404.

Also, in the first to third embodiments, the control device 400A, 400B is constituted by an independent ECU but may be part of the air conditioning ECU or the engine ECU.

In the first to third embodiments, the pressure sensing port 310a of the displacement control valve 300 is connected to the suction chamber 140 such that the suction pressure Ps prevails in the movable core accommodation space 324. Alternatively, the pressure sensing port 310a may be connected to the crank chamber 105 so that the pressure in the movable core accommodation space 324 may be equal to the pressure (crank pressure Pc) in the crank chamber 105.

In this case, the crank pressure Pc acts upon the valve element 304, and thus the controlled object setting means 402A, 402B of the control device 400A, 400B sets a target value (target crank pressure Pcset) for the crank pressure Pc, in place of the target suction pressure Psset. Then, the control signal calculation means 404 of the control device 400A, 400B calculates the control current I based on the difference between the discharge pressure Pd and the target crank pressure Pcset.

The crank pressure Pc is a control pressure for varying the displacement of the compressor 100. According to the present invention, the control current I supplied to the solenoid 316 of the displacement control valve 300 can be adjusted on the basis of the discharge pressure Pd (high pressure) and the target value of either one of the suction pressure Ps (low pressure) and the control pressure.

In the first to third embodiments, the compressor 100 used is a clutchless compressor, but may be a variable displacement compressor equipped with an electromagnetic clutch. Also, the compressor 100 to be used is not limited to a swash plate-type reciprocating compressor, and may be a wobble plate-type reciprocating compressor or a variable displacement compressor driven by an electric motor.

Also, in the first to third embodiments, the fixed orifice 103c is formed in the extraction passage 162 in order to regulate the flow rate of the extraction passage 162 and thereby raise the crank pressure Pc. The fixed orifice 103c may be replaced by a constriction with a variable flow area or a valve with an adjustable valve opening.

The valve element 304 of the displacement control valve 300 is applied with forces such that the discharge pressure Pd is countered by the suction pressure Ps or the crank pressure Pc. The displacement control valve 300 may be constructed such that while the discharge pressure Pd is countered by the suction pressure Ps, the crank pressure Pc is further applied to the valve element 304, or while the discharge pressure Pd is countered by the crank pressure Pc, the suction pressure Ps is further applied to the valve element 304. Also, the displacement control valve 300 may be equipped with a bellows or a diaphragm, and the discharge pressure Pd and the suction pressure Ps or the crank pressure Pc may be applied to the opposite sides of the bellows or diaphragm.

Further, in the foregoing embodiments, the displacement control valve 300 is inserted in the supply passage 160 connecting the discharge chamber 142 to the crank chamber 105. Alternatively, the displacement control valve 300 may be arranged in the extraction passage 162 connecting the crank chamber 105 to the suction chamber 140, instead of the supply passage 160. Namely, the displacement control valve 300 is applicable not only to inlet control for controlling the opening of the supply passage 160, but to outlet control for controlling the opening of the extraction passage 162.

The refrigerant to be used in the first to third embodiments is not limited to R134a or carbon dioxide, and some other new refrigerant may be used in the air conditioning system. Where carbon dioxide is used as the refrigerant, the seal area Sv of the displacement control valve 300 may be decreased, whereby the control range of the target suction pressure Psset can be widened.

The displacement control system for a variable displacement compressor according to the present invention is applicable not only to the refrigeration cycle of an automotive air conditioning system, but to refrigeration cycles in general, such as the refrigeration cycle of a room air conditioning system, and the refrigeration cycle of the freezer of a refrigerator-freezer.

1. A displacement control system for a variable displacement compressor, the variable displacement compressor being inserted, together with a heat radiator, an expansion device and an evaporator, in a circulation path for circulating a refrigerant, to constitute a refrigeration cycle of an air conditioning system and including a housing having a discharge chamber, a suction chamber, a crank chamber and cylinder bores defined therein, pistons received in the respective cylinder bores, a drive shaft rotatably supported in the housing, a conversion mechanism including a tiltable swash plate element for converting rotation of the drive shaft to reciprocating motion of the pistons, and a displacement control valve having a valve element applied with at least one of a pressure in a suction pressure region of the refrigeration cycle and a pressure in the crank chamber, and also with a pressure in a discharge pressure region of the refrigeration cycle and an electromagnetic force of a solenoid to open and close a valve opening and thereby vary the pressure in the crank chamber, the displacement control system comprising:
external information detection means for detecting one or more items of external information;
controlled object setting means for setting a controlled object to be controlled, in accordance with the external information detected by the external information detection means;
control signal calculation means for calculating a discharge displacement control signal in accordance with the controlled object set by the controlled object setting means; and
solenoid driving means for supplying the solenoid with an electric current based on the discharge displacement control signal calculated by the control signal calculation means,
wherein the controlled object setting means selects one control mode out of two or more control modes in accordance with the external information detected by the external information detection means, and sets the controlled object matching the selected control mode,
in a first control mode which is one of the control modes, the controlled object setting means sets a target pressure for one of the pressure in the suction pressure region and the pressure in the crank chamber, as the controlled object in accordance with the external information detected by the external information detection means, and
in a second control mode which is one of the control modes, the controlled object setting means sets a target working pressure difference for a difference between the pressure in the discharge pressure region and one of the pressure in the suction pressure region and the pressure in the crank chamber, as the controlled object in accordance with the external information detected by the external information detection means.

2. The displacement control system according to claim 1, wherein:
the external information detection means includes discharge pressure detection means for detecting the pressure in the discharge pressure region, and
when the first control mode is executed by the controlled object setting means, the control signal calculation means calculates the discharge displacement control signal based on the pressure in the discharge pressure region, detected by the discharge pressure detection means, and the target pressure.

3. The displacement control system according to claim 2, wherein the control signal calculation means calculates the discharge displacement control signal based on a difference between the pressure in the discharge pressure region and the target pressure.

4. The displacement control system according to claim 1, wherein:
the external information detection means includes evaporator outlet air temperature detection means for detecting temperature of air just left the evaporator, and target evaporator outlet air temperature setting means for setting a target temperature of the air just left the evaporator, and
when executing the first control mode, the controlled object setting means sets the target pressure such that the temperature of the air detected by the evaporator outlet air temperature detection means approaches the target temperature set by the target evaporator outlet air temperature setting means.

5. The displacement control system according to claim 1, wherein:
the external information detection means includes target torque setting means for setting a target torque of the variable displacement compressor, and
when executing the second control mode, the controlled object setting means sets the target working pressure difference such that torque of the variable displacement compressor approaches the target torque set by the target torque setting means.

6. The displacement control system according to claim 5, wherein:
the external information detection means includes air conditioner switch detection means for detecting a change from non-operating state to operating state of the air conditioning system, and
one of the condition which the controlled object setting means executes the second control mode is fulfilled that the change from non-operating state to operating state of the air conditioning system is detected by the air conditioner switch detecting means.

7. The displacement control system according to claim 6, wherein the second control mode is continuously executed for a predetermined time after the second control mode is started.

8. The displacement control system according to claim 5, wherein:
the air conditioning system is mounted on a motor vehicle,
the external information detection means includes idling detection means for detecting an idling state of the vehicle, and
one of the condition which the controlled object setting means executes the second control mode is fulfilled that the idling state of the vehicle is detected by the idling detection means.

9. The displacement control system according to claim 8, wherein the controlled object setting means stores the target pressure immediately before a switchover from the first control mode to the second control mode and, when the second control mode is canceled and the first control mode is again executed, sets the stored target pressure as an initial value for a new target pressure.

10. The displacement control system according to claim 5, wherein:
the air conditioning system is mounted on a motor vehicle,
the external information detection means includes engine load detection means for detecting a load on an engine of the vehicle, and
one of the condition which the controlled object setting means executes the second control mode is fulfilled that the load of the engine detected by the engine load detection means is larger than or equal to a predetermined value.

11. The displacement control system according to claim 5, wherein:
the air conditioning system is mounted on a motor vehicle,
the external information detection means includes engine load detection means for detecting a load on an engine of the vehicle, and heat load detection means for detecting a heat load both inside and outside of the vehicle, and
one of the condition which the controlled object setting means executes the second control mode is fulfilled that both of the engine load detected by the engine load detection means and the heat load detected by the heat load detection means are larger than or equal to respective predetermined values.

12. The displacement control system according to claim 10, wherein the condition for executing the second control mode by the controlled object setting means includes an additional condition that an amount of current supplied to the solenoid during execution of the first control mode is larger than that supplied to the solenoid if the second control mode is executed.

13. The displacement control system according to claim 10, wherein the controlled object setting means stores the target pressure immediately before a switchover from the first control mode to the second control mode and, when the second control mode is canceled and the first control mode is again executed, sets the stored target pressure as an initial value for a new target pressure.

14. The displacement control system according to claim 4, wherein, when executing the second control mode, the controlled object setting means sets the target working pressure difference such that the temperature of the air detected by the evaporator outlet air temperature detection means approaches the target temperature set by the target evaporator outlet air temperature setting means.

15. The displacement control system according to claim 14, wherein an electric current supplied to the solenoid in accordance with the target working pressure difference is restricted to a predetermined upper-limit value or less.

16. The displacement control system according to claim 14, wherein:
the air conditioning system is mounted on a motor vehicle,
the external information detection means includes heat load detection means for detecting a heat load both inside and outside of the vehicle, and
one of the condition which the controlled object setting means executes the second control mode is fulfilled that the heat load detected by the heat load detection means is larger than or equal to a predetermined value.

17. The displacement control system according to claim 14, wherein:
the air conditioning system is mounted on a motor vehicle,
the external information detection means includes heat load detection means for detecting a heat load both inside and outside of the vehicle, and rotational speed detection means for detecting a physical quantity corresponding to rotational speed of the variable displacement compressor, and
one of the condition which the controlled object setting means executes the second control mode is fulfilled that both of the heat load detected by the heat load detection means and the physical quantity detected by the rotational speed detection means are larger than or equal to respective predetermined values.

18. The displacement control system according to claim 1, wherein:
the air conditioning system further includes a hot gas heater cycle and is capable of switching between the refrigeration cycle and the hot gas heater cycle,
the variable displacement compressor constitutes not only part of the refrigeration cycle but also part of the hot gas heater cycle of the air conditioning system,
the external information detection means includes cycle detection means for detecting an operating cycle out of the refrigeration cycle and the hot gas heater cycle, and
during operation of the hot gas heater cycle, the controlled object setting means executes the second control mode.

19. The displacement control system according to claim 18, wherein:
the external information detection means includes exchanger outlet air temperature detection means for detecting temperature of air just left an air-heating heat exchanger constituting part of the hot gas heater cycle, and target exchanger outlet air temperature setting means for setting a target temperature of the air just left the air-heating heat exchanger, and
when executing the second control mode, the controlled object setting means sets the target working pressure difference such that the temperature of the air detected by the exchanger outlet air temperature detection means approaches the target temperature set by the target exchanger outlet air temperature setting means.

20. The displacement control system according to claim 18, wherein the discharge pressure detection means detects the pressure of the refrigerant in that portion of the discharge pressure region of the circulation path which is shared by the refrigeration cycle and the hot gas heater cycle.

21. The displacement control system according to claim 1, wherein, when a third control mode, which is one of the control modes, is executed, the controlled object setting means sets a target discharge pressure as a target for the pressure in the discharge pressure region, and sets the target working pressure difference such that the pressure in the discharge pressure region, detected by the discharge pressure detection means, approaches the target discharge pressure.
